(19) United States
(12) Patent Application Publication
(10) Pub. No.: US 2003/0208437 A1
(43) Pub. Date: Nov. 6, 2003

(54) Method and systems supporting trading of fungible ephemeral commodities and fungible non-ephemeral commodities incorporating transmission contracting

(76) Inventor: Ralph Samuelson, Mountain View, CA (US)

Correspondence Address: GLENN PATENT GROUP, 3475 EDISON WAY, SUITE L, MENLO PARK, CA, 94025, US

(21) Appl. No.: 10/296,564

(22) PCT Filed: May 23, 2001
(86) PCT No.: PCT/US01/16886

(51) Int. Cl. G06F 17/60

(52) U.S. Cl. 705/37

(57) ABSTRACT

The basic idea is to present bids and offers from several geographically distributed markets to a market participant as if they were all in a single market at the location where the participant wants to deliver or take delivery.

### TECHNICAL FIELD

This invention relates to the trading of fungible ephemeral commodities such as electrical power and bandwidth, as well as fungible non-ephemeral commodities such as natural gas, rice and fresh produce, incorporating not only trading the commodity but also its delivery.

### BACKGROUND ART

As used herein, a fungible commodity will refer to a commodity traded strictly in terms of the quantity of that commodity. No single unit of a fungible commodity is distinguishable from another unit of that commodity. A kilowatt-hour of 60 Hz AC power delivered on a power line is not distinguishable from another kilowatt-hour delivered at the same time to the same place on the same line.

A fungible, ephemeral commodity is a fungible commodity whose existence is extremely short-lived. Electrical power generation, network bandwidth, seats on an airplane and entry slots onto a freeway during rush hour are all examples of fungible commodities which exist but for a short duration of time. In contradistinction, starting lots in an assembly line produce tangible results, which may differ widely in content, thus showing an example of an ephemeral, non-fungible commodity.

Fungible, non-ephemeral commodities are fungible commodities whose existence extends for at least a period of time. The period during which a fungible commodity is saleable, will be referred to as the lifetime of the commodity.

The transmission time for most fungible, ephemeral commodities is nearly instantaneous. In some ways this is a direct consequence of their definition. If the transmission time was not nearly instantaneous, the commodities would essentially cease to exist before they could be received.

However, there are no known fungible non-ephemeral commodities possessing a nearly instantaneous transmission time. Consider natural gas flowing in a pipeline. This is the fastest, most efficient transmission mechanism known for that fungible non-ephemeral commodity. It is strictly limited to transmission speeds of less than the speed of sound. In fact safety concerns force the transmission speed to be far less than that. Thus, it can take one or more days for a specific ton of natural gas to travel from Houston to Seattle, for example. For the sake of simplicity of discourse, it will be assumed hereafter that transmission of a fungible, non-ephemeral commodity between geographically separated markets will require a non-trivial time for such transmissions.

Today, automated trading support mechanisms provide markets where commodities may be traded, but are deficient in supporting trade of not only the commodity, but also the delivery of that commodity.

Significant characteristics in the transfer of many fungible non-ephemeral commodities include the potential to use one or more distinct transfer mechanisms and their availability. Oil and grain are often shipped in containers by truck, train, barge and ship. For other fungible non-ephemeral commodities, airplanes are often used. In some cases, pipelines may also be part of the transport system. There is often an issue of when a shipment may be loaded and able to leave from a specific shipping point. There has to be enough transport capability available at the designated place of the designated type, whether truck, train, barge, ship, airplane, or pipeline, to insure completion of delivery of a specific shipment.

What is needed is a mechanism showing the relevant costs of transmission and/or transfer and/or transport for a given amount of such commodities from a given transportation hub at a given start date to be delivered to a given transportation hub by a given delivery date. What is further needed is a mechanism supporting trade contracting of not only amounts of fungible non-ephemeral commodities at specific prices and delivery locations, but also the transfer costs from source locations to delivery locations. What is additionally needed is the automated scheduling of transfer mechanisms to satisfy those commitments.

Consider for the moment the trading of electrical power. Before discussing the management and control problems associated with electrical power, it is important to consider some of the basic physical properties of electrical power distribution.

An AC power network is an electrical network connecting AC power generators to AC power loads on power lines controlled so that the network functions at an essentially constant frequency and uniform phase across the network. Drifts in phase are compensated by phase shifting devices to enforce the uniform phase property across the AC power network. Drifts in frequency are compensated at the generators. Such frequency variations are typically caused by variances between the loads and generated power. The effect of these compensations is to operationally provide essentially constant frequency and uniform phase throughout the AC power network. The AC power distribution frequency in the United States, Canada, Mexico and some other countries is 60 Hz and in some other countries is 50 Hz. In certain cases, the power is distributed in a 2-phase or a 3-phase transmission scheme.

A grid as used herein will refer to an electrical power system which may comprise more than one AC power network as well as DC power lines which may transfer energy between nodes of different AC power networks or is between nodes of a single AC power network.

Cities, generators and the like act as the nodes of an AC power network. A specific node may actually comprise more than one generator or load. A bus locally connects these local facilities of a node. High voltage AC transmission lines transfer power between the cities and the generators in major load centers of an AC power network. By way of example, in the United States, there's an AC power network called the Western States Coordinating Council, which covers British Columbia in Canada down to Northern Mexico and over to the Rocky Mountains. There's another AC power network in Texas and there's another AC power network essentially covering the rest of the United States and Canada, with the exception of a portion of Quebec. These three AC power networks are connected together by direct current lines to form the North American grid. They're not connected in AC. They are asynchronous, in that they are not synchronized either in terms of frequency or phase across the United States, Canada and northern Mexico.

Electrical power generation can readily be seen to be ephemeral and fungible. One kilowatt is reasonably treated the same as another, persisting only a relatively short period of time. Electrical power transmission can also be seen as ephemeral and fungible. Electrical power transmission is most commonly performed as AC transmission lines between nodes of an AC power network. DC power lines are used additionally to connect specific nodes of either a single or more than one distinct AC power networks.

Electrical power storage is of typically limited time duration, often for no more than a day or two. It should be noted that the interface points for power into such systems are ephemeral and fungible. It should also be noted that electrical power storage of more than a small part of one day's requirements cannot be effected for something the size of any of the major elements of the North American grid.

Power switching between lines involving high power (megawatts and above) is not commonly done. Power switching today typically involves no more than a fraction of a megawatt. However, if such systems components someday become capable of handling large power lines, power traversing the interfaces of such switches to a power network would still be ephemeral and fungible.

There are some basic physical properties distinguishing AC power distribution systems from other flow-based systems such as DC power, gas, water and oil transmission systems. AC power networks differ from gas, water, oil and other fluid flow distribution systems in that changes in power generation and loading propagate across such networks at approximately the speed of light. The effect of power generation and power loading effects the whole AC power network in a manner that, for practical purposes, is simultaneous.

Due to the stability of frequency and phase across an AC power network, changes in power have a super positioning effect. This insures that the power being carried on any line in the network is essentially a linear function of the generators and loads on the network. Furthermore, if a path of lines connects two nodes, generating power at the first node carried by the path is offset by power generated at the second node, as related by the above mentioned linear function.

These AC power networks are operated within a safe range, so that the patterns of flows are fairly predictable, given the configuration of the network does not change. The National Electric Reliability Council computes a system of a set of numbers called power transfer distribution factors available on the North American Reliability Council website, www.nerc.com, showing how the power is distributed across these various lines. It is a linear function of the amount injected, which changes sign when the direction of transfer changes from Node1 to Node2 into Node2 to Node1. Such functions are skew symmetric with respect to the nodes.

Consider a DC network: one can directly control the delivery of power from one point to another. This cannot be done on AC power networks. It is a characteristic of AC power networks that all lines are affected in roughly fixed proportions, by the previously mentioned transfer distribution factors and by the generating and loading at specific nodes.

A flowgate of a given AC power network will refer herein to a collection of at least one line whose total maximum safe carrying capacity will act as a congested element of the network, constraining AC power delivery between two or more nodes of that network.

All lines have maximum safe carrying capacities and thus could be considered flowgates, of a sort. However, historical congestion analysis of specific AC power networks reveals that only a small number of flowgates account for almost all congestion problems. Such flowgates will be herein referred to as significant flowgates.

The associated AC power transfer across a given flowgate is additive due to the super positioning effects previously discussed. Thus in sending 100 megawatts along a path, the transmission may have a 10% impact on the flowgate, putting 10 megawatts on the flowgate. A second generator may have a 5% impact on that flowgate. Generating 100 megawatt at the second generator would add 5 megawatts across the flowgate.

Note that these AC power functions are essentially linear and can be described by their coefficients.

Note that the facilities at these nodes, connected by an associated buss, often vary greatly in terms of generation capacity as well as loading capacity. By way of example, a city often consumes far more AC power than it generates. Another example, a node for a major hydroelectric dam such as Grand Coulee Dam would tend to generate far more AC power than it consumed.

The historical market of electrical power and electrical power transmission has, for a variety of historical and technological reasons, long been a notable exception to a commodity market approach. The ability of buyers and sellers to negotiate and implement deals remains severely restricted, even where the electric power industry has been deregulated. The usual argument for these restrictions revolves around reliability.

In the United States, the Federal Energy Regulatory Commission (FERC) called for the development of Regional Transmission Organizations (RTOs) to better coordinate markets and foster reliability (Docket No. RM99-2-00 issued May 13, 1999).

The electric power industry has a long history of using centralized dispatch to manage generation, as opposed to open markets. Centralized dispatch was suited to an industry consisting of vertically integrated monopolies. The traditional approach to RTO design so far has been to retain as much of this centralized control as possible, while opening access to competitive wholesale and retail participants. The result has been volatile prices, settlement disputes, and difficulties matching supply and demand on an instantaneous basis. The basic problem is that centralized dispatch does not work well where participants do not have common ownership or objectives.

RTO's have certain essential technical functions: providing an overall focus on reliability, regional security coordination and emergency operator intervention. RTO's have problems in the areas of scheduling, congestion management, ancillary service provisions, metering, billing and settlements. As used herein, an ancillary service often involves power generation. A power generation facility will reserve some production capacity to be available at the operators request in real-time to support balancing the network and to deal with emergency requirements which can rapidly be addressed by the reserved production capacity. Note that all the problem areas involve ephemeral, fungible electrical commodities or the economic results of transactions involving ephemeral, fungible electrical commodities.

Consider how AC power transfers are managed today in most of North America. Transmission rights are considered and negotiated in terms of point-to-point transfers within the network known as contract paths. Such thinking is contrary to the previously discussed physics of these AC power networks, because changes in power generation or load at any node have an essentially linear effect on all transmission lines in the network, and consequently impact all flowgates within that network to some extent.

This contract path system of scheduling power transmission reserves transmission rights along a particular, direct path through the AC power network. This is done by purchasing transmission rights from each of the transmission line owners for each of the lines making up the direct path. It often occurs that some constraint, occurring across a significant flowgate off that direct path, actually limits the transmission capability on the direct path.

The contract path system maintains the fiction that AC power can be directed to follow a path through the network chosen as one might with natural gas. By changing the valves, one can mythically direct AC power a particular way through the AC power network. The contract path system was put in place because it was thought conceptually easier since one only had to make reservations along the single path. The fundamental problem with the contract path approach is that the contract path arrangement for transmission does not accord with the way the power actually flows in an AC power network.

Today's contract path is based upon a first-come, first-served priority scheme. What is bought has very limited resale capability. By way of example, consider three nodes A, B and C forming a triangle in an AC power network. Suppose one bought a power transmission from A to B and bought a transmission from B to C. Using the contract path approach, that purchase does not mean one owns the power transmission from A to C, because contract paths are not additive. Owning power transmission from A to B and from B to C would not entitle power transmission from A to C. To transport from A to C, one would have to purchase separately transmission from A to C. This is because there might be some flowgate constraint which would not be met in the two separate paths which would be triggered in the combined path. So in the contract based market, which is the traditional market, once you have purchased the transmission from A to B, it's only value is for moving energy from A to B.

Today, there are several ad hoc approaches to limiting flow on one path because of the impact on another path. These contract path approaches ignore the physics of AC power networks. This leads to situations where even though some other path may actually be the constraint, when a particular path becomes over-constrained, cuts are issued to compensate. The central operator acts, because a flowgate will attempt to exceed its safe carrying capacity, forbidding transmission often across apparently irrelevant paths to compensate. The result is market chaos, since participants do not have reasonable assurance that their deals will actually go to delivery.

Another alternative approach is to take all of these generator costs, and the preferences of the buyers, into a mathematical optimization program, and figure out the optimal flow. This alternative approach has significant disadvantages. In a commercial market, getting people to reveal all their costs is quite difficult. Most people are very reluctant to do that. Further, such costs frequently change. The loads will have to reveal their preferences between consuming and non-consuming players, which is a tremendous informational burden. It is extremely unlikely that they could or would do it. Even if they did, all this information is a tremendous burden on the central operator collecting all the information.

Such an alternative approach requires two-way communication among all the players, with all these devices and systems to control, when the people consume power and when they turn on and off these distributed devices. It has proven impossible to provide the requisite level of reliable communication and direct control systems. Besides, people are unwilling to turn over control of their business lives to a central operator.

Another approach in industry is used by a system operator called PJM, for Pennsylvania, New Jersey and Maryland, who has developed a system called Locational Marginal Pricing(LMP). It is a central dispatched methodology. However, a local flow model is buried within it. It supports some centralized management of generators, related equipment and facilities in order to get a consistent solution that is based upon the power distribution matrix. This is a matrix of all power transfer distribution factors between nodes of the AC power network.

This approach suffers from at least the same problems facing any other centralized control scheme. There is a very limited amount of detailed information such a system can acquire, or use, to optimize AC power transfers. The power users are again blind to their options. The players cannot determine what works best for them. The central operator dictates to them. This situation is not optimal. Also, under LMP, prices are not known until after the deal is done, which may be at the time of delivery or a day ahead of delivery. Generation operators do not obtain the information they need to plan their hydroelectric, maintenance, and unit commitment decisions. Nor can price risks be easily hedged.

NERC has developed a methodology addressing flowgates to some extent. This is discussed in a document entitled “Discussion Paper on Aligning Transmission Reservations and Energy Schedules to Actual Flows”, distributed in November, 1998 by the NERC Transaction Reservation and Scheduling Self-Directed Work Team. This team proposed an electrical power industry shift to a system of reserving and scheduling transmission based on actual use of congested flowgates, which they called the FLOWBAT method. Their proposal suffers from a serious omission, it does not address the issue of allocating flowgate capacity when demand exceeds supply. By their silence on this issue, it appears that they would continue the current practice of first-come, first-served allocation. The flaws discussed above for centralized planning continue to be relevant in this approach.

NERC has also supported the General Agreement on Parallel Paths Experiment (GAPP). GAPP is a system whereby one transmission provider compensates a second transmission provider for the parallel power flows occurring on a second transmission provider's system caused by transactions authorized by the first transmission provider. GAPP relies on distribution functions, in this case called Transaction Participation Functions (TPFs). These distribution functions refer to transmission paths rather than flowgates. GAPP attempts to align compensation paid by transmission users with actual power flows. However, GAPP is strictly an after-the-fact settlement system. It alters the current contract path scheme only to redistribute the revenue. It does not attempt to allocate scarce transmission capacity.

Certain economists have expressed reservations with a flowgate market model utilizing a limited number of flowgates. They believe that leaving any flowgates out of the system, even minor ones, introduces gaming opportunities, which will cause the RTO to incur costs that must be paid by everyone. However, flowgates are numerous, and may arise unpredictably. It may not be feasible to trade every flowgate, as would be required to overcome the potential for gaming.

Supporting a large number of flowgates in a market model leads to several other problems. First, there is the technical problem of providing a user interface that makes it possible for users to cope with the complexity of numerous flowgates.

Second, there is the problem of maintaining liquidity with this many flowgates. Customers want to buy and sell the bundles of flowgates they need to move energy from one point in the network to another. They may not feel comfortable posting bids and offers for individual flowgates without an assurance that they will be able to buy or sell the remaining flowgates they need for their bundle at a reasonable price. If everyone withholds bids and offers from the market until they see bids and offers for all the flowgates they want to buy or sell, the market could significantly lack liquidity.

What is needed is a system supporting trading transmission rights and quantities of fungible ephemeral commodities in the form of complete bundles. These complete bundles would allow purchase of delivered energy with one transaction. The system should permit the bundles to be internally large and complicated, supporting trading in every flowgate right, and potential flowgate right and providing users with straightforward trading mechanisms for AC power transfer. Such trading mechanisms insure compliance with flowgate constraints, and thus the physics of AC power networks, while discouraging gaming opportunities.

What is needed is a mechanism showing the relevant costs of acquisition and transmission/transfer/transport for a given amount of fungible non-ephemeral commodities from a given transportation hub at a given start date to be is delivered to a given transportation hub by a given delivery date. What is further needed is a mechanism supporting trade contracting of not only amounts of fungible non-ephemeral commodities at specific prices and delivery locations, but also the transfer costs from source locations to delivery locations. What is additionally needed is the automated scheduling of transfer mechanisms to satisfy those commitments.

### SUMMARY OF THE INVENTION

Certain aspects of the invention include solutions to at least all the problems discussed herein.

The basic idea of the Macromarket is to present the bids and offers from several geographically distributed markets to a market participant as if they were all in a single market at the location where the participant wants to deliver or take delivery.

The price of each standing ask in its true locational market is increased by the cost of transmission to the participant's location, thus creating an “all-in” ask price. The price of each bid in its true location is reduced by the cost of transmission from the participant's location to the true locational market, creating an “all-in” bid price. Bids and asks may be ranked by price attractiveness to the participant based upon the all-in prices, regardless of their true locational market. The participant is able to see all bids and asks on a comparable basis.

Bids and asks may be shown only if transmission is actually available to the location where the participant wants to deliver or take delivery. It is assumed that the participant lifting a standing bid or ask will pay the transmission costs to or from their location.

The invention involves the trading and scheduling of macro markets. A macro market for a specific fungible commodity will account for a source market for the commodity, a destination market for the commodity and a transfer mechanism for the commodity from the source market to the delivery market. Note that the transport of fungible non-ephemeral commodities takes a significant amount of time, whereas transport of fungible ephemeral commodities is essentially instantaneous. Distinct embodiments of the macro market are thus required for these distinct types of fungible commodities.

This invention provides an answer to the central question of what is the total cost at delivery of a fungible commodity, an answer that existing trading mechanisms do not provide.

These and other advantages of the present invention will become apparent upon reading the following detailed descriptions and studying the various figures of the drawings.

### BRIEF DESCRIPTION OF THE DRAWINGS

FIG. 1 depicts a simplified system block of a computing system 3000 supporting interaction between a collection of certified clients and a computing system based upon supporting operations of a market engine, a scheduling engine, a settlement engine, in accordance with certain embodiments of the invention;

FIG. 2A depicts a refinement of computing system 3000 as a system diagram in FIG. 1; This computing system is comprised of a client computer collection and a server system 3500 coupled to a network 3200;

FIG. 2B depicts a refinement of computing system 3000 as a system diagram in FIG. 2A;

FIG. 3A depicts a virtual trading floor 1000, containing validated orders and market intervals with associated market states and further containing a certified client collection of certified clients in accordance with certain embodiments of the invention;

FIG. 3B depicts a market interval containing a product type, location and time interval in accordance with certain embodiments of the invention; The product types may include ephemeral, fungible commodities; All product types may be ephemeral, fungible commodities;

FIG. 3C depicts a refinement of a market interval as depicted in FIG. 3B further containing multiple time intervals;

FIG. 3D depicts a market interval shown as a transfer interval 1160 from FIG. 3A;

FIG. 3E depicts a macro market interval 1200 for a fungible, non-ephemeral commodity form FIG. 3A;

FIG. 3F depicts a macro market interval 1200 for a fungible, ephemeral commodity from FIG. 3A;

FIG. 4A depicts a detail flowchart of program system 6000 of FIG. 1 performing a method of interacting with at least a first active certified client and a second certified client both belonging to a certified client collection and supporting transactions involving purchase and transfer of at least one fungible commodity, either ephemeral or non-ephemeral;

FIG. 4B depicts a flowchart of operations for a method of a virtual trading floor trading ephemeral, fungible commodities in accordance with certain embodiments of the invention;

FIG. 5A depicts a validated order 1200 of the validated order collection in accordance with certain embodiments of the invention;

FIG. 5B depicts a refinement of FIG. 5A of a validated order 1200 of the validated order collection;

FIG. 6A depicts a refinement of FIG. 3B of a market interval of an energy product type;

FIG. 6B depicts a refinement of FIG. 3B of a market interval of an AC power transfer product type;

FIG. 6C depicts a refinement of FIG. 6B of a market interval of an AC power transfer product type;

FIG. 6D depicts a refinement of FIGS. 6B and 6C of a market interval of an AC power transfer point-to-point product type;

FIG. 7 depicts a validated order 1200 comprised of at least two validated orders, each with an associated market interval in accordance with certain embodiments of the invention;

FIG. 8A depicts a market interval of a DC power line in accordance with certain embodiments of the invention;

FIG. 8B depicts market interval 1100 of FIG. 3B further containing a window time interval during which the market interval is active only within the window time interval;

FIG. 8C depicts market interval 1100 of FIG. 8B containing a window time interval and multiple time intervals;

FIG. 9A depicts a detail flowchart of operation 6012 of FIG. 4 performing establishing a real time;

FIG. 9B depicts a detail flowchart of operation 2022 of FIG. 4 performing determining whether to remove a validated order from the validated order collection when its associated market interval's window has passed;

FIG. 10A depicts a detail flowchart of operation 6012 of FIG. 4 performing contracting to create an agreed contract from the validated order collection;

FIG. 10B depicts a detail flowchart of operation 2092 of FIG. 10A performing contracting to create an agreed contract from the validated order collection;

FIG. 11A depicts a detail flowchart of operation 2022 of FIG. 4 performing removing first bid and first ask validated orders from the validated order collection;

FIG. 11B depicts a detail flowchart of operation 2142 of FIG. 11A performing removing the first bid validated order from the multiple validated order, where the first bid validated order is originally contained in a multiple validated order containing a second validated order;

FIG. 11B depicts a detail flowchart of operation 2142 of FIG. 11A performing removing the first bid validated order from the multiple validated order, where the first bid validated order is originally contained in a multiple validated order containing a second validated order;

FIG. 11C depicts a detail flowchart of operation 2152 of FIG. 11A performing removing the first ask validated order from a multiple validated order, where the first ask validated order is originally contained in a multiple validated order containing a second validated order;

FIG. 12A depicts a detail flowchart of operation 6012 of FIG. 4 performing maintaining a certified client collection of certified clients;

FIG. 12B depicts a detail flowchart of operation 2022 of FIG. 4 performing receiving an order message from a certified client, processing and inserting it into the validated order collection, in accordance with certain embodiments of the invention where each of the validated orders of the validated order collection contains an ordering client;

FIG. 13 depicts a detail flowchart of operation 2092 of FIG. 10A performing notified biding and asking clients of the agreed contract for their respective validated orders;

FIG. 14A depicts a detail flowchart of operation 2004 of FIG. 4 performing calculating the market price of each market interval in the market interval collection;

FIG. 14B depicts a refinement of FIG. 3B of a market interval 1100 further containing a capacity option type 1118;

FIG. 14C depicts a refinement of the validated order of FIG. 5B further containing 1340 a capacity option price 1342;

FIG. 15A depicts a detail flowchart of operation 2112 of FIG. 10B performing determining bid order agreement with ask order for an associated capacity option market interval;

FIG. 15B depicts a detail flowchart of operation 2116 of FIG. 10B performing calculating an agreed option amount;

FIG. 15C depicts a detail flowchart of operation 2120 of FIG. 10B performing creating the agreed contract at the agreed price and the agreed option price for the agreed amount whenever the first bid order agrees with the first ask order in terms of the price and the option price;

FIG. 16A depicts a market state 1102 associated with a market interval 1100 as show in FIGS. 3A and 14B in accordance with certain embodiments of the invention;

FIG. 16B depicts a detail flowchart of operation 2004 of FIG. 14A performing calculating the capacity option price 1102-2 for the market state 1102 as shown in FIG. 16A of a market interval as shown in FIG. 14B containing a capacity option 1118;

FIG. 17 depicts a method of controlling the interaction between a client 1400 and a virtual trading floor comprising maintaining a session component 3300, participant component 3320 and market segment 3340 in accordance with certain embodiments of the invention;

### DETAILED DESCRIPTION OF THE INVENTION

Note that a commitment may be performed without requiring a schedule. For example, a first certified client may buy a certain amount of green tickets from a second certified client. In such situations, there might be no schedule generated for that commitment, but each certified client involved in the commitment would find the commitment referenced in the settlement.

A commitment may be scheduled for performance, but not actually be performed. For example, a network operator may curtail the availability of electrical power to consumers in certain areas to avert a blackout. Those consumers, while having scheduled commitments, did not fully enjoy the performance of the commitments. While the schedule would reflect the commitment, the settlements for those consumers would reference the actual performance of that commitment.

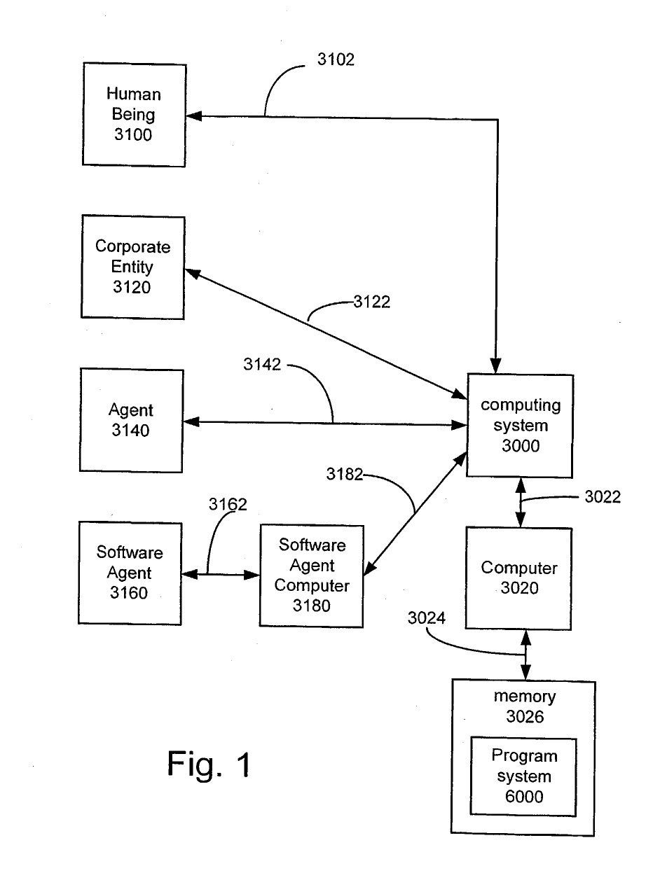

FIG. 1 depicts a simplified system block of a computing system 3000 supporting interaction between a collection of certified clients and a computing system based upon supporting operations of a market engine, a scheduling engine, a settlement engine, in accordance with certain embodiments of the invention.

Computing system 3000 is comprised of at least one computer 3020 coupled 3024 to computer readable memory 3026. The communication and interaction between computing system 3000 and computer 3020 is denoted by arrow 3022. Such communication and interaction 3022 may employ a variety of communications technologies, including a wireless physical transport layer in certain embodiments of the invention. Alternatively, communication and interaction 3022 may employ a wireline physical transport layer.

Note that these entities, the human being 3100, corporate entity 3120, agent 3140 and software agent 3160 may communicate with computing system 3000 by use of messages as represented by arrows 3102, 3122, 3142, and 3182, respectively. Such messages may use a wireline physical transport layer as represented by one or more of the arrows 3102, 3122, 3142, and 3182. Such messages may use a wireless physical transport layer as represented by one or more of the arrows 3102, 3122, 3142, and 3182. Such messages may use body signals in certain further embodiments of the invention. Such messages may further use hand signals. Such message may also use acoustic signaling of messages. Such messages may also further use verbal messages in a human language.

Note that certain embodiments of the invention may include only a market engine of the invention supporting at least any two of the following: a virtual trading floor 6032, bilateral trading 6042 and/or external market trading 6052, as well as maintain the commitment list 6062.

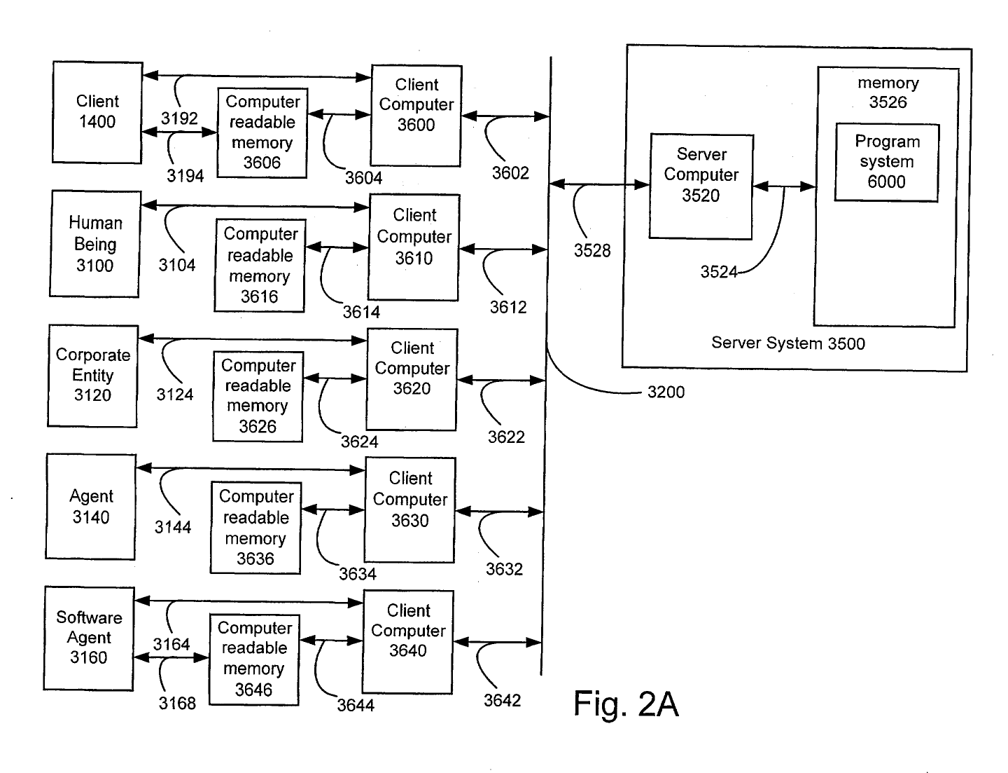

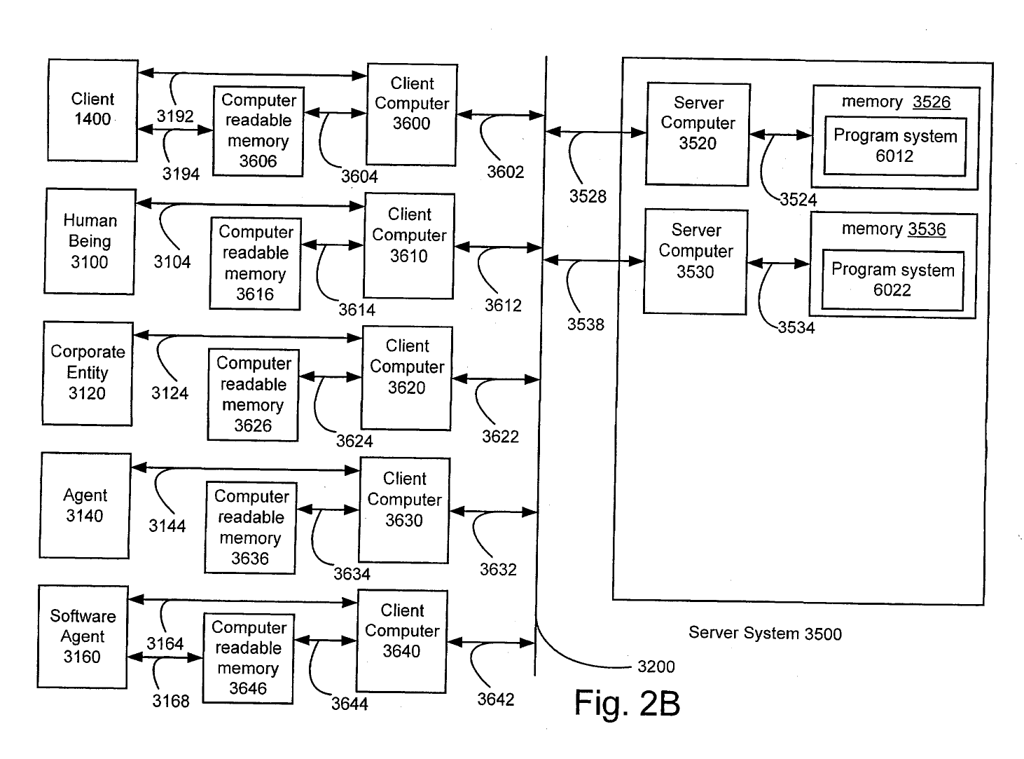

FIG. 2A depicts a refinement of computing system 3000 as a system diagram in FIG. 1. This computing system is comprised of a client computer collection and a server system 3500 coupled to a network 3200.

The client computer collection is comprised of at least one client computer 3600 operated (used) 3192 by certified client 1400. Client computer 3610 may be operated (used) 3104 by a human being as client 3100. Client computer 3620 may be operated (used) 3124 by a corporate entity as client 3120. Client computer 3630 may be operated (used) 3144 by an authorized agent as client 3140. The certified client may be represented by an agent, authorized by the first party, to act on behalf of the first party with respect to contracting.

Server system 3500 includes at least one server computer 3520 coupled to network 3200. Network 3200 further couples 3602, 3612, 3622, 3632 and 3642 to client computers 3600, 3610, 3620, 3630 and 3640, respectively. Network 3200 at least supports communication between client computers and at least one server computer 3520 of server system 3500. As used herein, the term network refers not only to Local Area Networks (LANs), but also to Wide Area Networks (WANs). Network supported communication as used herein includes, but is not limited to, digital communication protocols as well as analog communication protocols. Network supported communication as used herein further includes, but is not limited to, message passing protocols and packet based protocols. Network supported communication as used herein further includes, but is not limited to, communication protocols including TCP/IP. Network supported communication as used herein further includes, but is not limited to, communication protocols supporting the Internet..Network supported communication as used herein further includes, but is not limited to, communication protocols supporting the World Wide Web.

Client computer 3610 with coupled 3614 computer readable memory 3616 may be operated 3104 by a client 1400 further coupled 3194 to computer readable memory 3606. Client computer 3640 with coupled 3644 computer readable memory 3646 may be operated 3164 by a software agent as client 3160. The coupling 3194 may provide various personal optimizations and shortcuts, including, but not limited to, macro style functions and standard contract forms employed by the client 1400.

Server system 3500 may include at least one server computer 3520 coupled 3524 to computer readable memory 3526.

FIG. 2B depicts a refinement of computing system 3000 as a system diagram in FIG. 2A. This computing system is comprised of a client computer collection and a server system 3500 coupled to a network 3200.

Server system 3500 may include at least one server computer 3520 coupled 3524 to computer readable memory 3526.

Note that server computer coupled computer readable memory may contain a read-write accessible memory. Note that the read-write accessible memory may contain at least one mass storage unit. In certain a mass storage unit may include a disk drive. A mass storage unit may be accessed using a file management system. A mass storage unit may be accessed as a database.

Certain embodiments of the invention include a method of operating a client computer with a client computer message address interfaced with a reliable distributed system composed of a server system containing server computers with associated messaging addresses. The method includes a login procedure, a message composition procedure for an outgoing message to the reliable distributed system, and a message analysis procedure for an incoming message from the reliable distributed system.

The login procedure may maintain a list of messaging addresses of the collection of computers of the distributed system, a first login message and a login protocol and performs the following:

a. A first server computer of the server system is selected, and a first login message is sent to the associated address of the first server computer.

b. If there is a first acknowledgement message received from the first server computer message address then the login procedure proceeds to perform the login protocol.

c. Whenever the login protocol fails with the first server computer or

whenever there is no acknowledgement message received from the first server computer within a predetermined amount of time or

whenever there remain server computers in the server system for which login has not been attempted,

a new first server computer is selected from the remaining server computers of the server system and these steps are repeated.

d. Whenever the login protocol succeeds with the first server computer, the first server computer is designated the connection computer.

The message composition procedure for an outgoing message to the distributed system may comprise performing the following: Maintaining a list of message formats. Determining the selection of a first message format. Using the first message format to create an outbound message. Sending the outbound message to the connection computer.

The message analysis procedure for an incoming message from the distributed system may comprise performing the following: Receiving the message from the connection computer. Validating the received message creates a valid received message.

An object class structure may be used to support message passing, each message comprising a message type and at least one message field. Each message-passing object comprises handling an unknown message type and handling for an unknown message field.

Handling an unknown message type for a received message from a first object by a second object may comprise the first object sending the second object a reply message indicating unknown received message type and referencing the received message.

Handling an unknown message field of the received message by the second object may comprise handling the other fields of the received message by the second object.

Certain embodiments of the invention may operate a reliable distributed system of a collection containing at least one process group running on several computers comprising receiving confirmed messages from certified clients and maintaining a group state. Each process group computer possesses a messaging address. The computers of a process group communicate amont themselves with a virtually synchronous messaging system.

Receiving a confirmed message from a certified client may occur at one computer of the first collection of computers running the process group. Upon receipt the receiving computer broadcasts the confirmed message from the certified client to all computers of the first collection of computers.

Maintaining a group state on each computer of the first collection of computers of the process group may comprise the following operations: Each computer processes the confirmed message from the certified client to create a group state candidate. Each computer broadcasting a virtually synchronous group state candidate message to the other computers. Each computer receives the virtually synchronous group state candidate messages of the other computers. Each computer analyzes the received virtually synchronous group state candidate messages and its own virtually synchronous group state candidate to create a new group state.

Certain embodiments of the invention employ a messaging system for message passing concurrent objects, instances of which reside on computers each possessing a controller belonging to a collection of computers comprising ABCAST protocol and GBCAST protocol. The ABCAST protocol is an atomic broadcast protocol used to communicate messages between object instances across the computers of the collection of computers. The GBCAST protocol is a global broadcast protocol to communicate messages between controllers of the computers of the collection of computers.

Certain embodiments of the invention employ an object class structure executing in a process group of computers communicating with each other via a messaging protocol supporting at least virtual synchrony. Each instance of each object of the object class structure comprises an object instance clone reading on each of the process group computers.

Each object instance may further send and receive messages from other object instances and each object instance clone communicates with messages to other object instance clones of the same object instance.

Each object class may further possess a state, which is a member of a collection of states. Each instance of each object class state changes as an atomic event. All activities of each object class occur as atomic events. Atomic events may be triggered by message reception. Each instance of an object receives messages triggering state changes in the same sequence as all other instances of that object. This enforces all R-Object instances changing their state through exactly the same sequence without having to directly communicate that new state amongst themselves.

A concurrent computing entity may reside on each of the computers of a process group of computers where it owns access to a binary file or memory used for storing the resilient object instance state. It executes updates to the binary file as a transaction. The storage in the binary file is organized into table objects. Each table object consists of a set of records.

In certain embodiments of the invention, all individuals wishing to access the RTO systems must establish a login session with the appropriate system. This applies to RTO participants, RTO staff, as well as other systems that are integrated into the platform. Each login session is established under the protocols of the security integrated into the RTO systems. The location of the session may not be important to the system, allowing the RTO to operate multiple sites. The multiple RTO sites may each operate as a monitor site, a failover site, or to share workload. Login session at multiple sites can be connected to server system 3500 simultaneously, and are synchronized by server system 3500.

Each RTO participant may share the same security information for authorized scheduling entities (ASEs), RTO operators, and transmission operators (TOs). This security information may be maintained through the registration interface, through which all permissions for each participant may be maintained. This information may be used to validate all login sessions.

Access to the server system 3500 and/or server computer 3560 may be obtained by establishing a login session with the appropriate system. This may apply to RTO participants, including ASEs, RTO operators, and TOs, as well as other computer systems, such as EMS/SCADA systems. This ensures that only authorized individuals and systems can access the APX systems.

The security information may be checked each time that an RTO participant or computer system attempts to log into server system 3500 or server computer 3520 or web server 3560. Login information may include a login ID and password. Login information may be passed in an encrypted form. If access is permitted, the login session may then be configured in accordance with the permissions associated with the particular login ID.

This ensures that each RTO participant may access only those systems and data to which the participant is authorized.

Access to each system may also be controlled in terms of modes including at least receiving data, placing bids, and viewing positions. This mechanism restricts each login session to its authorized systems, making available only its authorized information, and does so in only its authorized modes.

Each login session may include a real-time, two-way communication session or a secure web-based connection between the RTO participant software and the servers. Each session may rely on one or more. encryption mechanisms to encode the communication. For the real-time connections, this mechanism may include frequent encryption key change, which may further be invisible to the user to ensure privacy of communication between each RTO participant and the systems 3500 and 3560.

Certain embodiments may include help desk staff. The help desk staff may not have access to market data, scheduling data, or any participant business data. Further, the help desk staff may be unable observe A/S auction or EIS market activity. The help desk staff may not know who or what was selected or dispatched, or at what price. The help desk staff may in certain embodiments only monitor system conditions, such as the number of sessions logged on, the level of activity in the market (for performance monitoring), and when bidding is opened or closed. The help desk staff may maintain reliable data archives and backups on all servers. The help desk staff may perform these maintenance and archival tasks without regard to content.

In certain embodiments, certified users are primarily approved scheduling entities (ASEs), the control area operators (CAOs), and the RTO operators (regardless of location). These certified users may participate in the RTO at the operational level, using services of the server system 3500 or web server 3560.

Certain embodiments include a method of operating a client computer communicatively coupled to an engine system. The engine system includes at least one of the following: a market engine, a scheduling engine and a settlement engine. The client computer communicating with the engine system supports certified client transactions regarding market intervals. Each market interval contains at least one fungible, ephemeral commodity, a location and a time interval.

An engine group includes at least two engine group computers, each implementing a market engine, a scheduling engine or a settlement engine. Note that two engine group computers may redundantly implement a market engine. Alternatively, two engine group computers may redundantly implement a scheduling engine. Additionally, two engine group computers may redundantly implement a settlement engine. An engine group may include two engine group computers implementing different engines. The engine group provides multiple access mechanisms by which communications between the client computer and the engine system may take place.

Note that the engine system may include one or more engine groups. Note that the engine system may be implemented as an engine group.

The client computer may interact with at least one member of the engine group by establishing the client computer as the certified client through communication with the engine system and participating as the certified client communicating with the engine system.

The engine group advantageously removes the potential for a single point of failure in the communication between the client and the engines implemented by the engine group, increasing the overall communication system reliability.

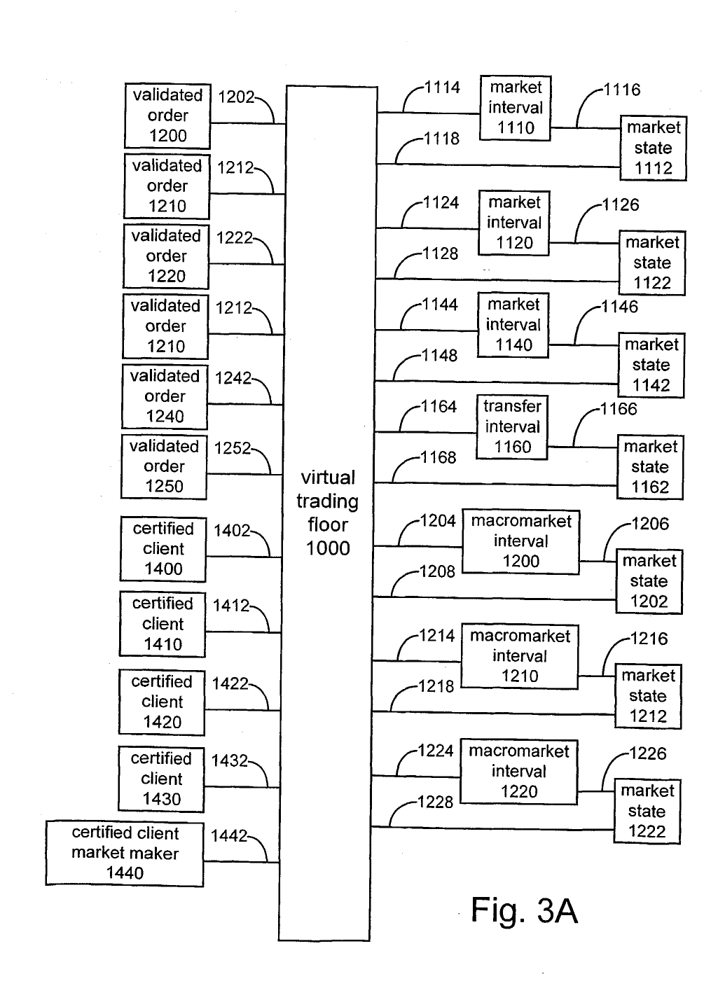

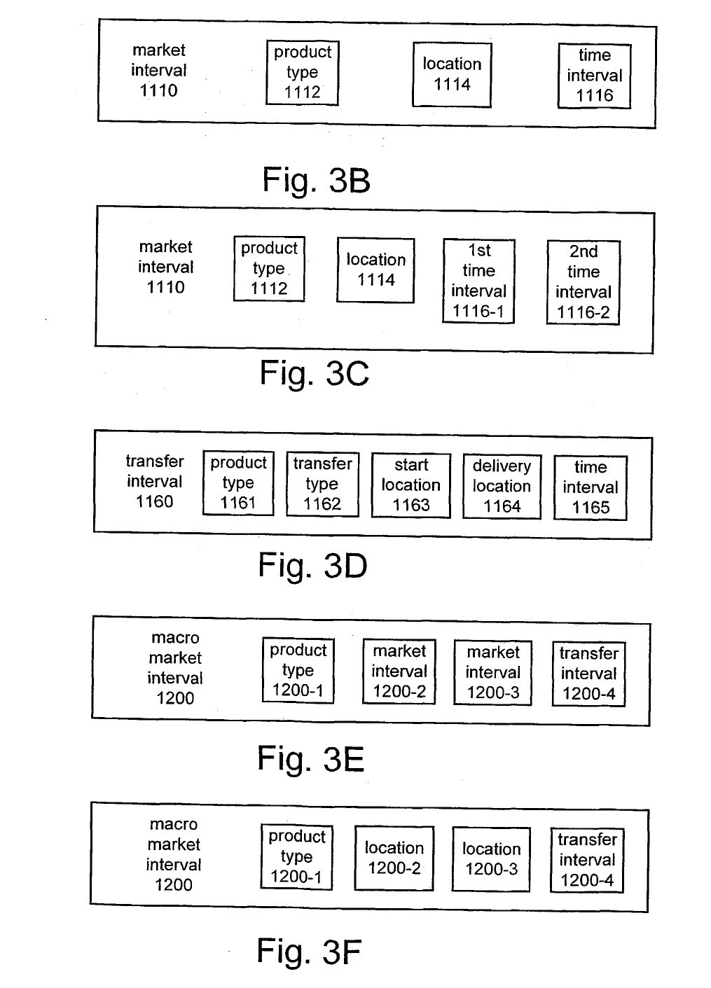

FIG. 3A depicts a virtual trading floor 1000, containing validated orders and market intervals with associated market states and further containing a certified client collection of certified clients in accordance with certain embodiments of the invention.

The virtual trading floor mechanism 1000 comprises a collection of market intervals, each with an associated market state, and validated orders. A market contains a product type and a location. Trading in the market is done in terms of market intervals 1100,1120, and 1140 as well as specialized market intervals including transfer intervals 1160 and macro market intervals 1200, 1210 and 1220.

Each market interval of a market contains the market product type, market location, plus a calendar scheme with an interval end. The market state of a market interval comprises a market price for the market interval product type at the market interval location during the market interval time interval.

Note that some market intervals such as market interval 1160 are further denoted as transfer intervals, further shown in FIG. 3D. A transfer interval 1160 includes a location further distinguished as having a start location 1163 and a delivery location 1164. For many fungible non-ephemeral commodities, not only is a product type 1161 specified, but also a transfer type 1162 is specified. By way of example, a container of wheat may be transported by truck, train, barge or ship. As with other market intervals, there is a time interval 1165 involved, which designated the expected time of transport.

Macro market intervals 1200,1210, and 1220 are also shown. These are specialized market intervals which reflect at least one source market interval and at least one destination market interval. FIG. 3E provides a more detailed discussion of macro markets for fungible non-ephemeral commodities. FIG. 3F provides a more detailed discussion of macro markets for fungible ephemeral commodities.

A validated order may contain an amount of the market interval product type, a price for the market interval product type. The validated order is either a bid validated order or an ask validated order.

FIG. 3A also depicts a certified client collection comprised of certified clients. Certified clients may include, but are not limited to, human beings. Certified clients may further include, but are not limited to, corporate entities. Certified clients may also further include agents authorized by the certified clients to represent them in interactions regarding the virtual trading floor. Certified clients may also further include software agents executing on software agent computers authorized by certified clients to represent them in interactions regarding the virtual trading floor. Note that in certain embodiments of the invention, the market engine manages and/or maintains the certified client collection.

A virtual trading floor may support trading ephemeral, fungible commodities of an electrical power grid containing at least one AC power network. Each AC power network further contains a node collection of at least two nodes. The product type of the market intervals of the market interval collection may be a member of a product type collection comprised of energy and AC power transfer. The location of a market interval having an energy product type may be a first node of the node collection of an AC power network contained in the electrical power grid. The location of a market interval having an AC power transfer product type may be from a first node of a first AC power network contained in the electrical power grid to a second node of the first AC power network.

Some certified clients may be market makers 1440. Market makers are market participants who have taken on the additional role of attempting to arbitrage in transmission.

For fungible ephemeral commodities, market makers 1440 use the computing system to access point-to-point transmission orders and individual flowgate orders. Market makers 1440 may also have their own inventories of point-to-point transmission rights and flowgate rights, which they may or may not choose to post in the market.

Market makers 1440 may also be described as market providers in certain economic systems, where the term “market maker” has a pre-established and divergent meaning.

Market makers 1440 may receive “request for quotes” from other certified clients. In energy markets, these requests may be triggered whenever a participant opens an Energy Market screen for a particular facility, market, strip, and lot size. Using mathematical models of their own choosing, market makers may generate quotes for the transmission products displayed on the participant's screen. These quotes may be submitted to the computing system as market maker quotes.

The computing system may identify market maker quotes, and may keep them separate from the standing orders submitted by participants who actually own, or wish to buy, transmission. The reason is that the market maker quotes are derived from the standing orders, and market makers will not want to consider these derived quotes when creating new derived quotes. If they did, the number of possibilities for them to consider would explode, with no gain in information.

Market makers may interactively submit their quotes to the computing system. Speed in calculating quotes would be of the essence, since the only real risk to the market maker is posting a quote based on stale data.

Market makers may withdraw their quotes at any time, even after the participant has signaled his/her acceptance and it is on the way back through the network to the market maker. Market makers may not, however, refuse an order that is based on a quote that is still posted at the time they receive that order. Not having this rule would open the way for all kinds of gaming by market makers, which would undermine the integrity of the market. Like market makers everywhere, market makers in this system must be constantly reevaluating and updating their quotes.

A single market could have multiple competing market makers. Market makers may compete for competitive advantage based on the speed of their responses (thereby minimizing losses due to stale quotes), the ability of their algorithms to find the best price, their skill at maintaining strategic inventories of flowgates and point-to-point transmission rights, and their operating costs. This kind of competition encourages innovation, low costs, and liquidity, and will be good for the participants.

Market makers may be allowed to go into a negative position in individual flowgate rights, or even point-to-point rights, assuming they have sufficient credit with the RTO. If the market maker is still in a negative position at the scheduling deadline, he/she will be billed for the missing transmission rights, just as if they had submitted an uncovered schedule. To the participant who bought the transmission right from a market maker with a negative position, the transmission right is the same as any other. This rule provides a “cushion” that insures liquidity in the market. It means that market makers always have a way to quote a price for any transmission the participants may desire to buy or sell. The rule is harmless, in such embodiments, all of these transmission rights affect only the financial settlement.

Allowing market makers to go into negative positions in transmission rights also removes any incentive to hoard transmission rights. Without this rule, hoarding could be attractive in a system with hundreds of flowgates, since one participant could buy up all the rights to some flowgate that is not perceived as scarce for very little money. Without a liquid market in even one flowgate, it might be impossible for market makers to create quotes for many point-to-point rights.

There may be rules prohibiting a single participant from owning more than a certain fraction of a single flowgate. But such rules require policing and can get in the way of some participants with legitimate needs, and might not be effective if several participants act in concert (with or without explicit collusion).

The RTO's role may begin with the initial auctions. The RTO auctions both flowgate rights and point-to-point rights, based on an algorithm that maximizes the value received. This algorithm is similar to the algorithm currently used by PJM to auction FTRs.

Under normal conditions, the RTO stands behind all point-to-point rights, both those auctioned initially and those created (and recreated) by market makers and participants. Any participant can obtain reasonable price certainty by buying a point-to-point right. In the event that one of the 400 flowgates has to be de-rated, the RTO may buy back the flowgate rights or optionally redispatch around the problem.

In the event that a new constraint appears in the system that is not one of the traded flowgates, the RTO may buy back existing flowgate rights in order to force flows to meet the new constraint, or optionally redispatch around the problem. No new flowgates are ever added after the initial auction. With hundreds of degrees of freedom, the RTO has plenty of levers to deal with virtually any constraint that may occur. The real-time LMP runs as if the constraints are on the traded flowgates that the RTO actually uses to limit flow, not the unrepresented constraint.

In general, not representing a constraint in the network creates a potential opportunity for gaming, since the participant could create congestion on the constraint, then get paid by the RTO to mitigate it. However, in a system with hundreds of flowgates, an individual participant is not likely to be able to create much congestion on an unrepresented constraint without exceeding the limit on flowgates that are represented. If the congestion on the unrepresented constraint is due to an equipment failure, the RTO may pay to mitigate the problem, as it would do under FTRs.

In extreme situations, it may not be possible for the RTO to buy back flowgate rights or redispatch at a reasonable cost. In these situations, the RTO may be allowed to buy-back rights from participants on a pro-rata basis at a preset ceiling price.

Such bundled point-to-point rights possess at least the following advantages.

Forward price discovery of congestion costs allows planning of unit maintenance, unit commitment, and hydroelectric resources.

Bundled point-to-point rights advantageously minimize market involvement of RTO in the market, including involvement in the selection of commercially significant flowgates.

Easily traded market instruments for hedging congestion costs, providing virtually complete hedging of risk for participants.

Flowgates provide a mechanism for resolving seams issues between control areas.

Bundled point-to-point rights with a flowgate foundation assure least cost redispatch within system constraints.

Bundled point-to-point rights with a flowgate foundation give a complete set of congestion costs between all locations at delivery time.

Bundled point-to-point rights with a flowgate foundation support participants producing and consuming energy with minimal advance scheduling.

Bundled point-to-point rights with a flowgate foundation provide the ability to handle large numbers of constraints.

FIG. 3B depicts a market interval containing a product type, location and time interval in accordance with certain embodiments of the invention. The product types may include ephemeral, fungible commodities. All product types may be ephemeral, fungible commodities.

Location may refer to a single node. A node may be specified geographically. A node may be specified in terms of nodes in a network. The network may contain both a collection of nodes and a collection of lines, each line extends from a first node to a second node. Note that the term line as used herein does not exclusively imply a straight line. A node may be specified in terms of a node of a network contained in a grid of one or more networks, further containing special lines connecting nodes of potentially distinct networks.

Location may additionally refer to a transition or transfer from a first node to a second node.

A market interval has a uniform price for its product type within the time interval. A market interval may also have uniform buy and sell positions, to support uniform movement of the product within the market interval. A single market interval may be seen to act as an independent commodity market of the fungible, ephemeral commodity for its product type.

FIG. 3C depicts a refinement of a market interval as depicted in FIG. 3B further containing multiple time intervals.

In FIG. 3C, two time intervals are depicted by way of example. More than two time intervals may be contained in one market interval. Each of the multiple time intervals may not temporally overlap the other contained time intervals of the market interval.

Note that both market positions and market prices may have similar formats. Both market positions and market prices may include representations as a quantity, which is a scalar value, and a point or set of points over a calendar line known herein as a time interval. Arithmetic functions and operations including but not limited to addition, subtraction, negation, multiplication, minimums and maximums are readily extended to apply to these scalar values over calendar time.

As stated elsewhere in this document, the minimal condition placed upon the time intervals of a market interval is that they not overlap. It is often advantageous to place further constraints on market intervals in terms of the orders submitted to a virtual trading floor.

These constraints can be thought of as follows: if order market intervals were the footprints on the calendar line, a strip may be considered the shoe that left those footprints. While there may be an indefinitely large number of orders covering the calendar line, there are usually only a small finite number of shoes, i.e. strips involved with those orders. An order's market interval may be further constrained to only begin at discrete points on the calendar line.

By way of example, consider the following strips:

An hourly strip is a market interval that allows orders to be submitted for market intervals that start on the hour and last for an hour.

A daily strip is a market interval that allows orders to be submitted for market intervals that start on the local time day boundary and end on local time boundaries. As used here, local time means the local time with respect to the location of the market segment. Note that because the strip is specified in terms of the local time, the actual length may vary depending on the current calendar day at that location. For example, during daylight to standard time transition in the United States, the daily strip spans 25 hours instead of the standard 24 hours.

A daily off-peak strip allows orders for market intervals that start at the local time day boundary and continue until 6:00 AM local time and then start again at 10:00 PM and continue until the ending day boundary.

Other examples may include, but are not limited to, five-minute strips, monthly strips and yearly strips. The set of strips a market may support must ensure that orders are submitted for non-partially overlapping intervals. These constraints require that strips either be sub-periods of another strip or compliment the strip. An example of two strips, which cannot co-exist in the same market, are the weekly strip and the monthly strip. This is because not all weeks are sub-periods of any one month.

A lot is the quantity in multiples of which an order must be contracted.

A basic function of a market segment is to match buy and sell orders at a single price. Certain embodiments of the invention will satisfy differing rules established for different markets belonging to different regulatory regions regarding that matching process. By way of example, in a bid-ask market, an incoming buy/sell order is immediately matched with the best buy/sell order standing in the market with the trade price as the limit price of the standing order.

In a call-auction market, buy and sell orders are collected together in a batch and matched sometime after they have been submitted. All orders in the batch are traded at the same price, which is calculated based upon the limit prices of all orders in the batch.

FIG. 3D depicts a market interval shown as a transfer interval 1160 from FIG. 3A.

Note that some market intervals such as market interval 1160 are further denoted as transfer intervals, further shown in FIG. 3D. A transfer interval 1160 includes a location further distinguished as having a start location 1163 and a delivery location 1164. For many fungible non-ephemeral commodities, not only is a product type 1161 specified, but also a transfer type 1162 is specified. By way of example, a container of wheat may be transported by truck, train, barge or ship. As with other market intervals, there is a time interval 1165 involved, which designated the expected time of transport.

FIG. 3E depicts a macro market interval 1200 for a fungible, non-ephemeral commodity form FIG. 3A.

The product type 1200-1 will reflect the fungible non-ephemeral commodity, which may include not only a designation such as wheat or coal, but also a designation of the quality of the commodity. The location is seen as involving two markets 1200-2 and 1200-3, which share the same product type 1200-1 as macro market 1200. The transfer interval 1200-4 should have a start time within the time intervals of market interval 1200-2 and a delivery time within the time intervals of market interval 1200-3.

FIG. 3F depicts a macro market interval 1200 for a fungible, ephemeral commodity from FIG. 3A.

Because of the essentially simultaneous delivery of fungible ephemeral commodities such as electric power, the time intervals of the source and delivery markets, as well as the transfer interval are identical. This is a fundamentally simpler situation than fungible non-ephemeral commodities present. Rather than keeping track of market intervals across distinct time intervals, all trading and scheduling occurs in the same time interval.

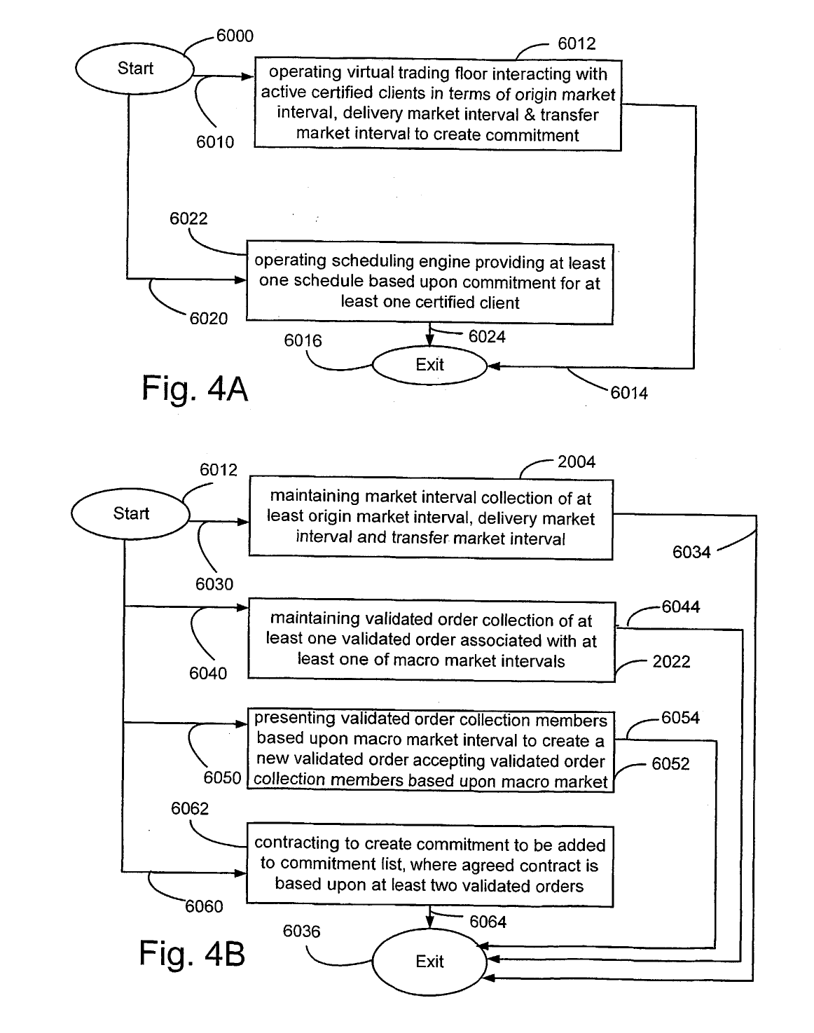

FIG. 4A depicts a detail flowchart of operation 6000 of FIG. 1 performing a method of interacting with at least a first active certified client and a second certified client both belonging to a certified client collection and supporting transactions involving at least one fungible, ephemeral commodity in terms of macro market intervals.

Arrow 6010 directs the flow of execution from starting operation 6000 to operation 6012. Operation 6012 performs supporting a virtual trading floor interacting with at least two active certified clients in terms of at least one macro market to create a commitment. Arrow 6014 directs execution from operation 6012 to operation 6016. Operation 6016 terminates the operations of this flowchart.

Arrow 6020 directs the flow of execution from starting operation 6000 to operation 6022. Operation 6022 performs operating a scheduling engine providing at least one schedule based upon accessing the commitment list for at least one of the certified clients belonging to the certified client collection. Arrow 6024 directs execution from operation 6022 to operation 6016. Operation 6016 terminates the operations of this flowchart.

FIG. 4B depicts a flowchart of operations for a method of a virtual trading floor trading ephemeral, fungible commodities in accordance with certain embodiments of the invention.

Operation 6012 starts the operations of this flowchart. Arrow 2002 directs the flow of execution from operation 6012 to operation 2004. Operation 2004 performs maintaining a market interval collection of market intervals, at least one transfer market interval and at least one macro market interval. Arrow 2006 directs execution from operation 2004 to operation 2008. Operation 2008 terminates the operations of this flowchart.

Arrow 2020 directs the flow of execution from starting operation 6012 to operation 2022. Operation 2022 performs maintaining a validated order collection of validated orders. Arrow 2024 directs execution from operation 2022 to operation 2008. Operation 2008 terminates the operations of this flowchart.

These operations may be supported by a program step residing in a coupled computer readable memory on at least one computer in a computing system supporting the virtual trading floor for ephemeral, fungible commodities.

As used herein, the term computer refers to devices including instruction set computers, inferential computers, and analog computers, as well as aggregates of these basic kinds of computers. A computer will also refer to informational appliances incorporating one or more computers in their construction. Such informational appliances may be physically distinct units, or they may be tangibly integrated into other devices, or they may be tangibly integrated into the physically mobile neighborhood of one or more human beings.

As used herein, certain computers, including instruction-processing computers and inferential computers, include coupled computer readable memory to hold what will be termed herein as instructions. Instructions as used herein with regard to instruction set computers will refer to information controlling state transitions of such instruction computers. Based upon the current individual instructions or collections of instructions being executed, and its internal state, the instruction-processing computer will determine its future state. Note that these instructions may either be directly executed by the instruction-processing computer or may be interpretively executed by the instruction-processing computer.

Instructions as used herein with regard to inferential computers refer to information presented to the inferential computer used to infer the future state of the computer based upon an inference base of the inferential computer directed by the presented instruction. Such an inference base may reside internal to the inferential computer in certain cases, or reside in coupled computer accessible memory, which may be both read and written by the inferential computer. Note that inferential computers include, but are not limited to, machines executing various forms of Horn clause predicates as well as constraint rules, pattern recognition templates, fractal pattern templates and fuzzy logic predicate structural elements.

Analog computers as used herein include, but are not limited to, devices directly coupling to analog circuitry. Such analog circuitry as used herein includes, but is not limited to, radio frequency IF stages, opto-electronic interfaces such as lasers embedded in fiber optic communications systems, audio and video pattern recognition circuitry, audio and video output devices. Analog computers as used herein include, but are not limited to, acoustic interfaces to humans, audio and visual identification portals to the contracting of AC power transfer regarding flowgates, encoding and decoding mechanisms used in long distance communication and interfaces to recording devices of agreed contracts.

A program step as used herein refers to instructions in a form executably directing and/or inferentially directing a computer. The program step may reside in computer readable memory accessibly coupled to the computer. Note that, program steps may be native executable instructions of an instruction-processing computer. Program steps may be interpretively executed instructions of an instruction-processing computer.

Certain embodiments of the invention include program operating systems comprised of program steps residing on at least one computer readable memory accessibly coupled to a computer. These program operating systems will be referred to as the program system hereafter. Such embodiments advantageously support utilization of computers to implement such embodiments.

Certain embodiments advantageously support the operations discussed herein as program steps included in a program system executed by a computing system including at least one computer with coupled computer readable memory. The program steps are not required to all belong to the same instruction execution family, they may advantageously include program steps executing on multiple computers.

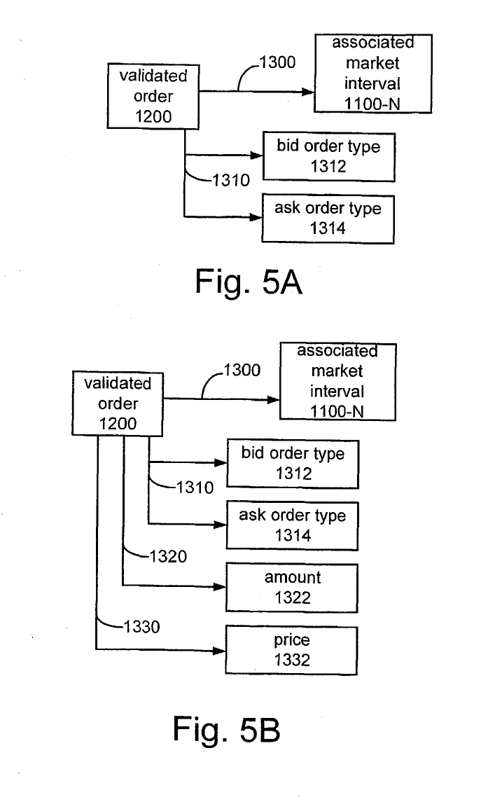

FIG. 5A depicts a validated order 1200 of the validated order collection in accordance with certain embodiments of the invention.

Validated order 1200 has an associated 1300 market interval 1100-N of the market interval collection. The market interval collection is separately maintained in certain embodiments of the invention. Maintaining the validated order collection and market interval collections may be coupled.

Each validated order 1200 further contains a member of the order type collection 1310 which is either a bid order 1312 of the associated 1300 market interval 1100-N or an ask validated order 1314 of the associated 1300 market interval 1100-N.

FIG. 5B depicts a refinement of FIG. 5A of a validated order 1200 of the validated order collection.

As depicted in FIG. 5A, validated order 1200 has an associated 1300 market interval 1100-N of the market interval collection. The market interval collection is separately maintained in certain embodiments of the invention. Maintaining the validated order collection and market interval collections may be coupled.

As depicted in FIG. 5A, each validated order 1200 further contains a member of the order type collection 1310 which is either a bid order 1312 of the associated 1300 market interval 1100-N or an ask validated order 1314 of the associated 1300 market interval 1100-N.

A validated order may contain 1320 an amount 1322 of the product type 1110-N of the associated 1300 market interval 1100-N.

A validated order may contain 1330 a price 1332 of the product type 1110-N of the associated 1300 market interval 1100-N.

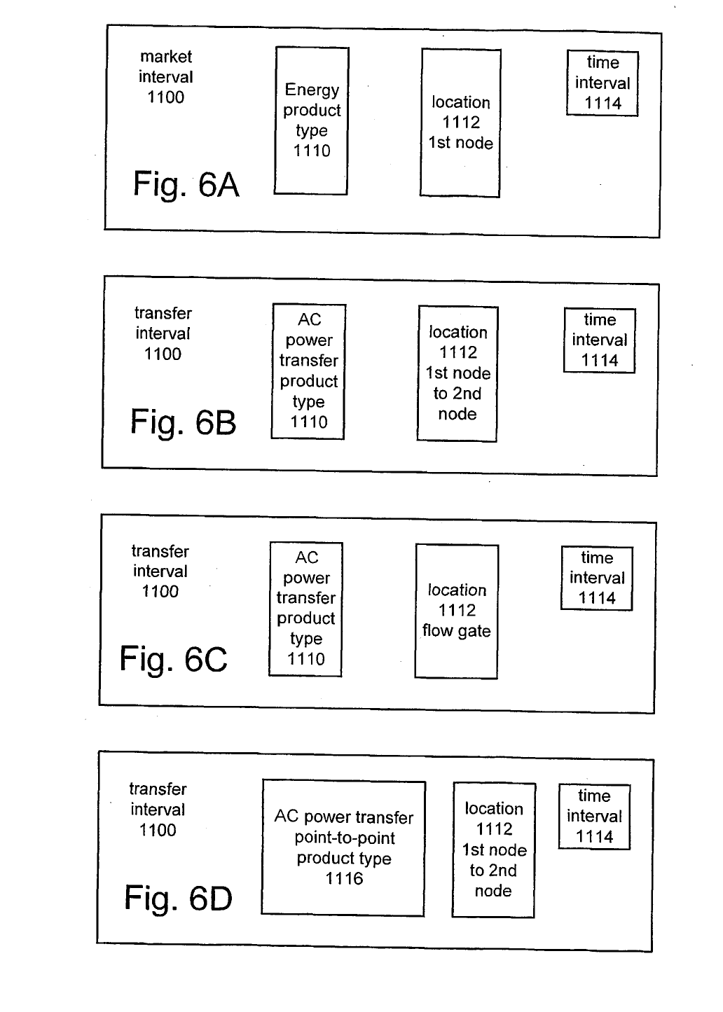

FIG. 6A depicts a refinement of FIG. 3B of a market interval of an energy product type. The product type 1110 of the market interval is further described as an energy product type 1110. The location 1112 is a first node of an AC power network contained in the electrical power grid.

FIG. 6B depicts a refinement of FIG. 3B of a market interval of an AC power transfer product type. The product type 1110 of the market interval is further described as an Energy product type 1110. The location 1112 is from a first node of a first AC power network contained in the electrical power grid to a second node of the first AC power network. Note that this form of location represents a transmission between the first node of the first AC power network and the second node of the first AC power network.

FIG. 6C depicts a refinement of FIG. 6B of a market interval of an AC power transfer product type. The product type 1110 of the market interval is described as an Energy product type 1110. The location 1112 is a flowgate of the flowgate collection of a first AC power network contained in the electrical power grid. Note that flowgates can represent a congestion constraint across more than one transmission line, and may not have a specific first node to second node description.

Such embodiments of the invention of a flowgate market interval are advantageous in providing a market to trade transfer capability between users. Because of the linear nature of AC power transfer throughout an AC power network, these transfer rights can be linearly accumulated to insure the contracted transfers are physically feasible in satisfying the overall flowgate constraints of the AC power network.

FIG. 6D depicts a refinement of FIGS. 6B and 6C of a market interval of an AC power transfer point-to-point product type. The product type 1116 of the market interval is a refinement of the AC power product type 1110 as depicted in FIG. 6B. The product type 1116 of the market interval is further described as an Energy product type 1110. The location 1112 is from a first node of a first AC power network contained in the electrical power grid to a second node of the first AC power network.

Note that as in FIG. 6B, this form of location represents a transmission between the first node of the first AC power network and the second node of the first AC power network. However, a market interval for an AC power transfer point-to-point product type further possesses all the ancillary flowgate transmission rights required for the power transmission from the first node to the second node of the AC power network.

Such market intervals support trading in bundles of flowgates rights as point-to-point rights. From a user perspective, point to point rights are what the market participants really want to buy and sell. They are much simpler to deal with and comprehend than flowgate rights.

In terms of maintaining market liquidity, participants should be very comfortable posting bids and offers for point-to-point AC power transfer rights, since they constitute complete products from a participant perspective.

Bids for AC power transfer point-to-point market intervals are comprised of bids for at least one flowgate transmission right sharing the same location. Bids for AC power transfer point-to-point market intervals may further comprise bids for each of the flowgates of the flowgate collection sharing the same location. Bids for AC power transfer point-to-point market intervals may further comprise transmission rights for at least one flowgate with differing location. This advantageously supports creating transmissions canceling adverse effects on one or more flowgates.

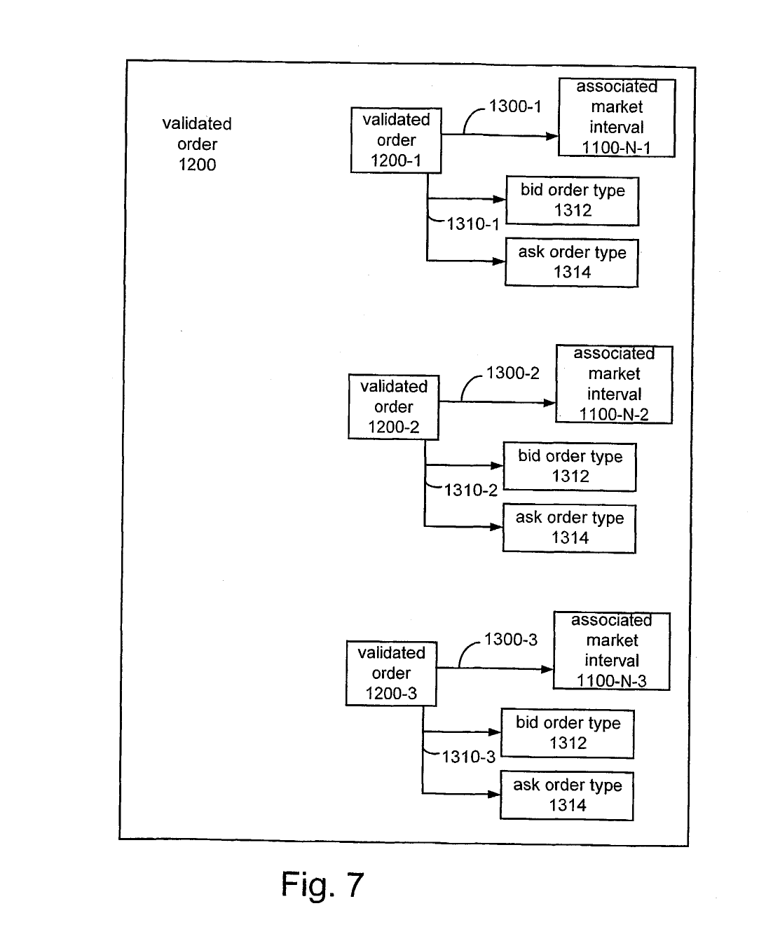

FIG. 7 depicts a validated order 1200 comprised of at least two validated orders, each with an associated market interval in accordance with certain embodiments of the invention.

Validated order 1200-1 has an associated 1300-1 market interval 1100-N-1 of the market interval collection. Validated order 1200-1 further contains a member of the order type collection 1310-1 which is either a bid order 1312 of the associated 1300 market interval 1100-N-1 or an ask validated order 1314 of the associated 1300 market interval 1100-N-1.

Validated order 1200-2 has an associated 1300-2 market interval 1100-N-2 of the market interval collection. Validated order 1200-2 further contains a member of the order type collection 1310-2 which is either a bid order 1312 of the associated 1300 market interval 1100-N-2 or an ask validated order 1314 is of the associated 1300 market interval 1100-N-2.

Validated order 1200-3 has an associated 1300-3 market interval 1100-N-3 of the market interval collection. Validated order 1200-3 further contains a member of the order type collection 1310-3 which is either a bid order 1312 of the associated 1300 market interval 1100-N-3 or an ask validated order 1314 of the associated 1300 market interval 1100-N-3.

There may be no specific limit to the number of validated orders comprising a validated order. There may be a limit to the number of validated orders comprising a validated order.

The associated market intervals of multiple validated orders within a validated order may share the same product type. The associated market intervals of multiple validated orders within a validated order may share the same location.

The associated market intervals of multiple validated orders within a validated order may differ in product type. The associated market intervals of multiple validated orders within a validated order may differ in location.

As discussed in the background, the physics of AC power networks indicates each AC power network contained in the electrical power grid further contains a flowgate collection of flowgates. Each flowgate location being either from an associated first node of the AC power network to an associated second node of the AC power network, or in the case of a collection of constrained transmission lines, will be denoted by a flowgate designator. An AC power transfer amount from node1 to node2 produces an amount of AC power transfer across the flowgate as essentially an associated linear, skew-symmetric function of the amount from node1 to node2, for each of the flowgates of the flowgate collection. For each of the flowgates of the flowgate collection, there is at least one market interval in the market interval collection of AC power transfer product type with the flowgate location.

Each validated order of the validated order collection with the AC power transfer product type of the associated market interval may further contain an amount. A validated order of AC power transfer product type from the first node to the second node may be further comprised of a validated order of the flowgate associated market interval. The amount ordered for that flowgate is essentially the associated linear, skew-symmetric function of the amount from the first node to the second node, for each of the flowgates of the flowgate collection.

Note that there may be a price associated with each validated order of the AC power transfers of the flowgates. There may be a price associated with the AC power transfer from the first node to the second node.

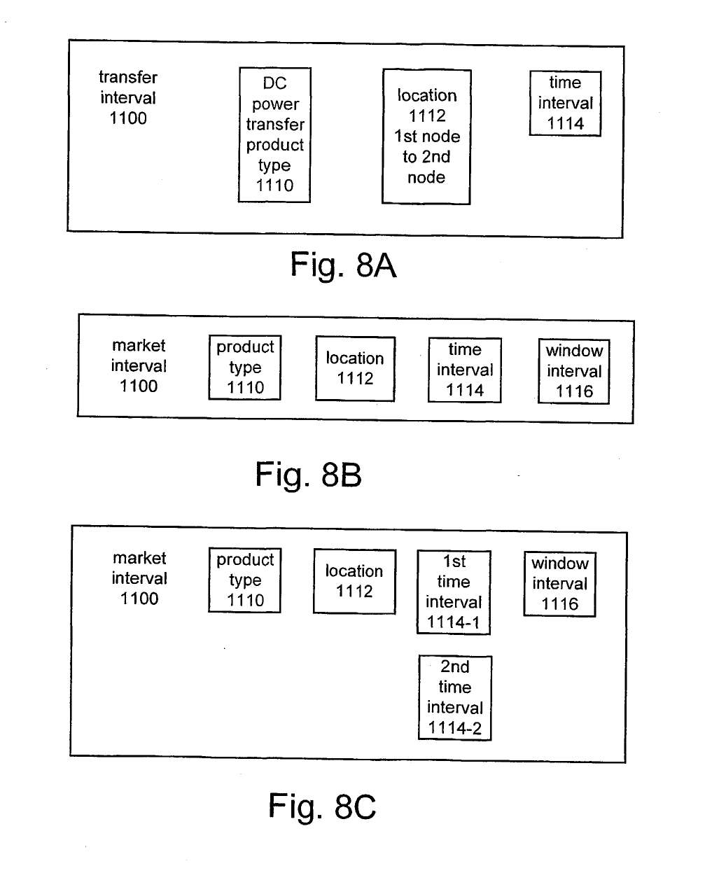

FIG. 8A depicts a market interval of a DC power line in accordance with certain embodiments of the invention. An electrical power grid may further contain a DC power line collection of at least one DC power line at the location of the DC power line from a first node of a first AC power network to a second node of a second AC power network. The product type collection further comprises DC power transfer. For each DC power line of the DC power line collection, there is at least one associated market interval with DC power transfer product type, with the location as the location of the DC power line.

FIG. 8B depicts market interval 1100 of FIG. 3B further containing a window time interval during which the market interval is active only within the window time interval. The window time interval of the market interval entirely occurs before the time interval contained in the market interval for each market interval.

FIG. 8C depicts market interval 1100 of FIG. 8B containing a window time interval and multiple time intervals. Each of the time intervals does not overlap the other time intervals. The window time interval occurs before each of the time intervals.

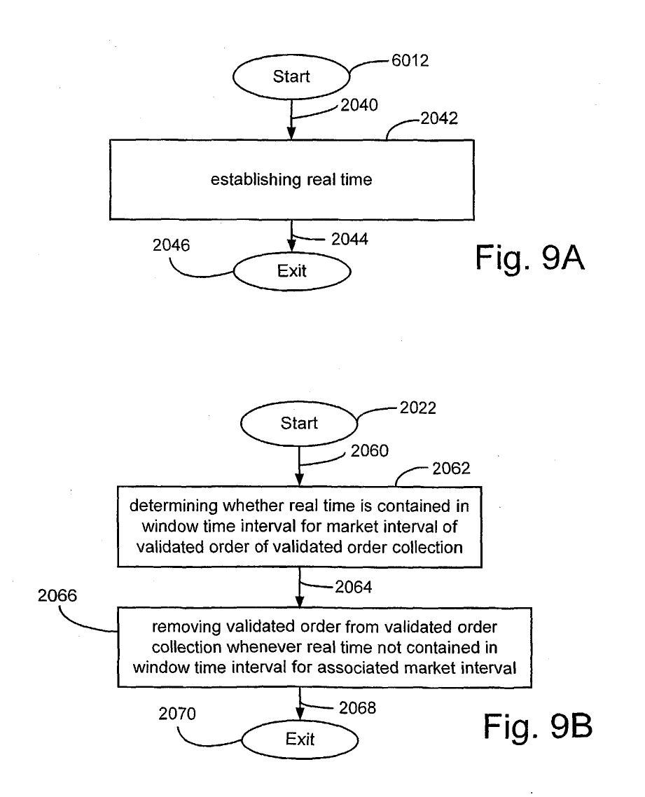

FIG. 9A depicts a detail flowchart of operation 6012 of FIG. 4 performing establishing a real time. A real time is a temporal reference used to determine whether the window time interval contains the real time, making validated orders with the associated market interval active.

Arrow 2040 directs the flow of execution from starting operation 6012 to operation 2042. Operation 2042 performs establishing a real time. Arrow 2044 directs execution from operation 2042 to operation 2046. Operation 2046 terminates the operations of this flowchart.

These operations may be supported by a program step residing in a coupled computer readable memory on at least one computer in a computing system supporting a virtual trading floor for ephemeral, fungible commodities.

FIG. 9B depicts a detail flowchart of operation 2022 of FIG. 4 performing determining whether to remove a validated order from the validated order collection when its associated market interval's window has passed.

Arrow 2060 directs the flow of execution from starting operation 2022 to operation 2062. Operation 2062 performs determining whether the real time is contained in the window time interval for the market interval of the validated order of the validated order collection. Arrow 2064 directs execution from operation 2062 to operation 2066. Operation 2066 performs removing the validated order from the validated order collection whenever the real time is not contained in the window time interval for the associated market interval of the validated order. Arrow 2068 directs execution from operation 2066 to operation 2070. Operation 2070 terminates the operations of this flowchart.

These operations may be supported by a program step residing in a coupled computer readable memory on at least one computer in a computing system supporting a virtual trading floor for ephemeral, fungible commodities.

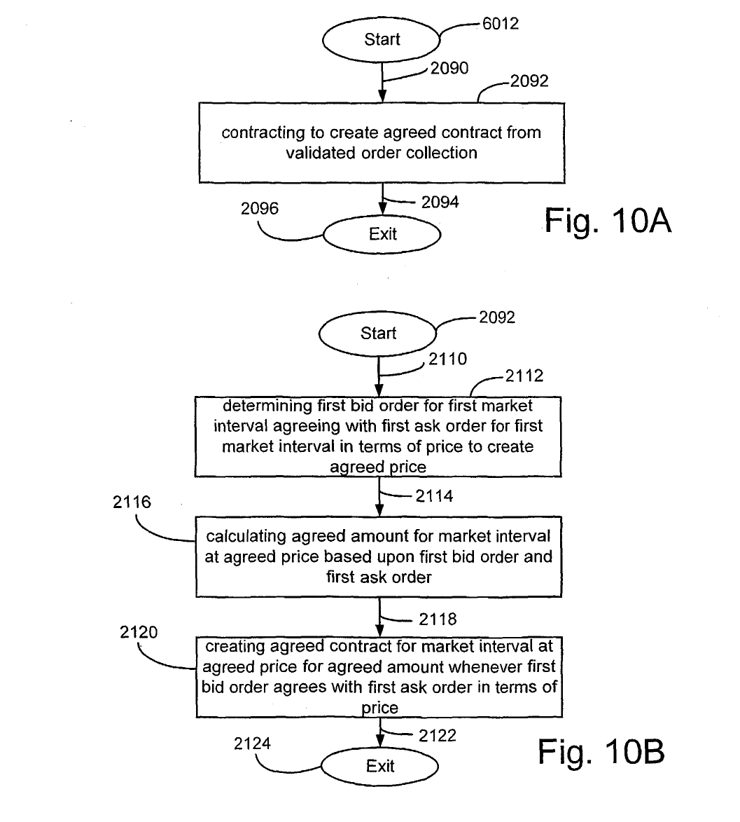

FIG. 10A depicts a detail flowchart of operation 6012 of FIG. 4 performing contracting to create an agreed contract from the validated order collection.

Arrow 2090 directs the flow of execution from starting operation 6012 to operation 2092. Operation 2092 performs contracting to create an agreed contract from the validated order collection. Arrow 2094 directs execution from operation 2092 to operation 2096. Operation 2096 terminates the operations of this flowchart.

These operations may be supported by a program step residing in a coupled computer readable memory on at least one computer in a computing system supporting a virtual trading floor for ephemeral, fungible commodities.

FIG. 10B depicts a detail flowchart of operation 2092 of FIG. 10A performing contracting to create an agreed contract from the validated order collection.

Arrow 2110 directs the flow of execution from starting operation 2092 to operation 2112. Operation 2112 performs determining a first bid order for a first market interval agreeing with a first ask validated order for the first market interval in terms of price to create an agreed price. Arrow 2114 directs execution from operation 2112 to operation 2116. Operation 2116 performs calculating an agreed amount for the market interval at the agreed price based upon the first bid order and first ask validated order. Arrow 2118 directs execution from operation 2116 to operation 2120. Operation 2120 performs creating the agreed contract for the market interval at the agreed price for the agreed amount whenever the first bid order agrees with the first ask validated order in terms of the price. Arrow 2122 directs execution from operation 2120 to operation 2124. Operation 2124 terminates the operations of this flowchart.

Not all validated orders may have a price associated with them. Consider an AC power transfer from node1 to node2 of an AC power network. Assume that the AC power network has a collection of at least three flowgates. A validated order for an AC power transfer amount from node1 to node2 may contain validated orders for an associated amount for each flowgate of the flowgate collection. Each of the flowgate validated orders may contain prices for their respective flowgate. The agreed amount would be calculated based upon the associated amounts and pricing of the flowgates. Alternatively, all validated orders may have a price associated with them.

These operations may be supported by a program step residing in a coupled computer readable memory on at least one computer in a computing system supporting a virtual trading floor for ephemeral, fungible commodities.

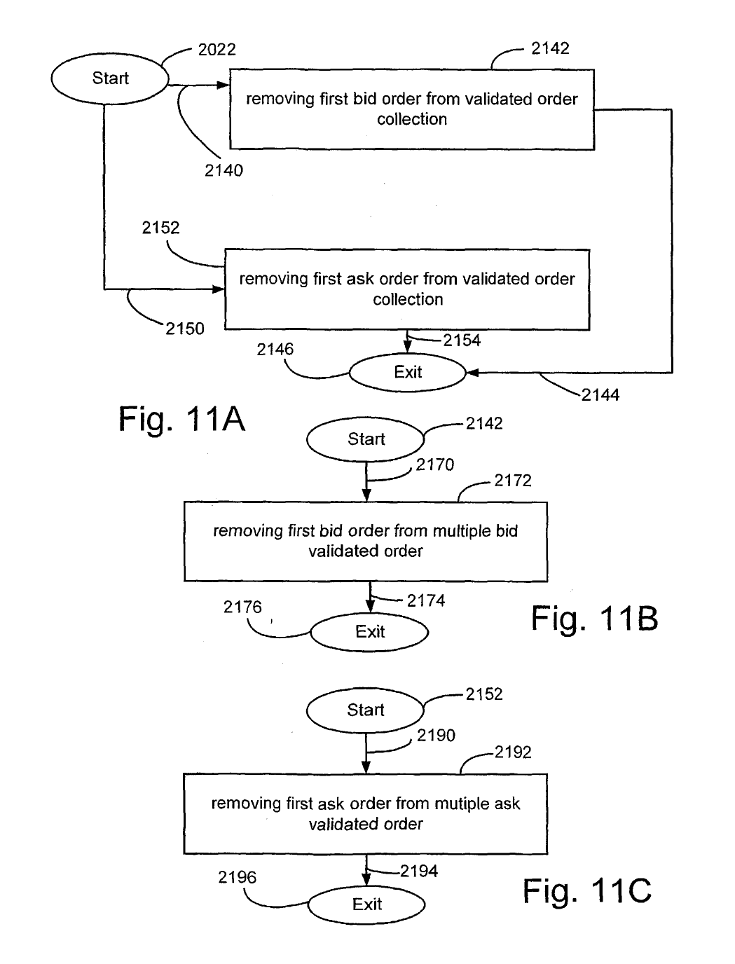

FIG. 11A depicts a detail flowchart of operation 2022 of FIG. 4 performing removing first bid and first ask validated orders from the validated order collection.

Arrow 2140 directs the flow of execution from starting operation 2022 to operation 2142. Operation 2142 performs removing the first bid validated order from the validated order collection. Arrow 2144 directs execution from operation 2142 to operation 2146. Operation 2146 terminates the operations of this flowchart.

Arrow 2150 directs the flow of execution from starting operation 2022 to operation 2152. Operation 2152 performs removing the first ask validated order from the validated order collection. Arrow 2154 directs execution from operation 2152 to operation 2146. Operation 2146 terminates the operations of this flowchart.

These operations may be supported by a program step residing in a coupled computer readable memory on at least one computer in a computing system supporting a virtual trading floor for ephemeral, fungible commodities.

FIG. 11B depicts a detail flowchart of operation 2142 of FIG. 11A performing removing the first bid validated order from the multiple validated order, where the first bid validated order is originally contained in a multiple validated order containing a second validated order.

Arrow 2170 directs the flow of execution from starting operation 2142 to operation 2172. Operation 2172 performs removing the first bid validated order from the multiple validated order contained in the validated order collection comprises removing the first bid validated order from the validated order. Arrow 2174 directs execution from operation 2172 to operation 2176. Operation 2176 terminates the operations of this flowchart.

These operations may be supported by a program step residing in a coupled computer readable memory on at least one computer in a computing system supporting a virtual trading floor for ephemeral, fungible commodities.

FIG. 11C depicts a detail flowchart of operation 2152 of FIG. 11A performing removing the first ask validated order from a multiple validated order, in accordance with embodiments of the invention where the first ask validated order is originally contained in a multiple validated order containing a second validated order.

Arrow 2190 directs the flow of execution from starting operation 2152 to operation 2192. Operation 2192 performs removing the first ask validated order from the validated order. Arrow 2194 directs execution from operation 2192 to operation 2196. Operation 2196 terminates the operations of this flowchart.

These operations may be supported by a program step residing in a coupled computer readable memory on at least one computer in a computing system supporting a virtual trading floor for ephemeral, fungible commodities.

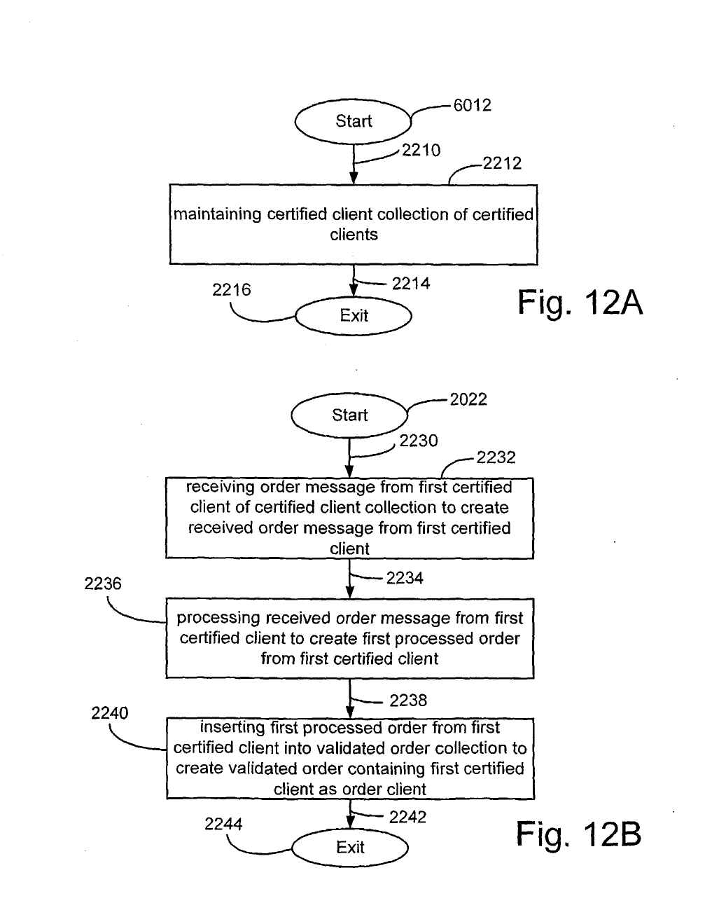

FIG. 12A depicts a detail flowchart of operation 6012 of FIG. 4 performing maintaining a certified client collection of certified clients.

Arrow 2210 directs the flow of execution from starting operation 6012 to operation 2212. Operation 2212 performs maintaining a certified client collection of certified clients. Arrow 2214 directs execution from operation 2212 to operation 2216. Operation 2216 terminates the operations of this flowchart.

These operations may be supported by a program step residing in a coupled computer readable memory on at least one computer in a computing system supporting a virtual trading floor for ephemeral, fungible commodities.

FIG. 12B depicts a detail flowchart of operation 2022 of FIG. 4 performing receiving an order message from a certified client, processing and inserting it into the validated order collection, in accordance with certain embodiments of the invention where each of the validated orders of the validated order collection contains an ordering client.

Arrow 2230 directs the flow of execution from starting operation 2022 to operation 2232. Operation 2232 performs receiving an order message from a first of the certified clients of the certified client collection to create a received order message from the first certified client. Arrow 2234 directs execution from operation 2232 to operation 2236. Operation 2236 performs processing the received order message from the first certified client to create a first processed order from the first certified client. Arrow 2238 directs execution from operation 2236 to operation 2240. Operation 2240 performs inserting the first processed order from the first certified client into the validated order collection to create a validated order containing the first certified client as the order client contained in the validated order collection. Arrow 2242 directs execution from operation 2240 to operation 2244. Operation 2244 terminates the operations of this flowchart.

These operations may be supported by a program step residing in a coupled computer readable memory on at least one computer in a computing system supporting a virtual trading floor for ephemeral, fungible commodities.

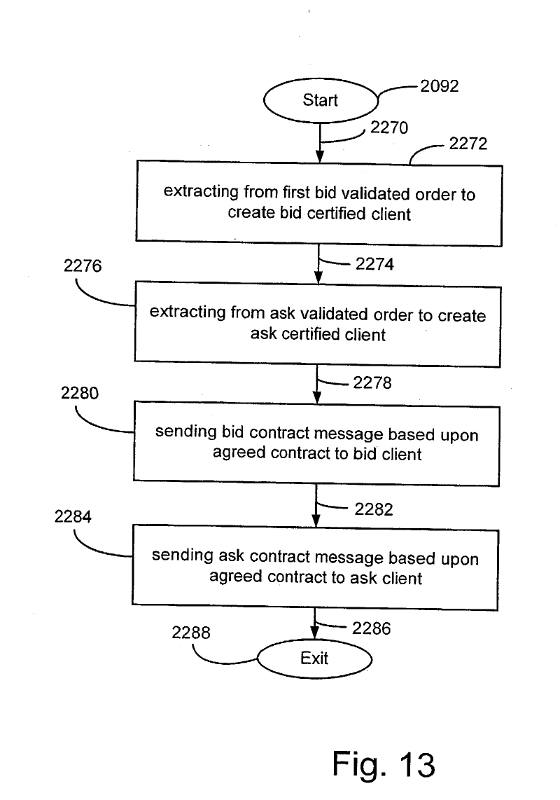

FIG. 13 depicts a detail flowchart of operation 2092 of FIG. 10A performing notified biding and asking clients of the agreed contract for their respective validated orders.

Arrow 2270 directs the flow of execution from starting operation 2092 to operation 2272. Operation 2272 performs extracting from the first bid validated order to create a bid certified client. Arrow 2274 directs execution from operation 2272 to operation 2276. Operation 2276 performs extracting from the ask validated order to create an ask certified client. Arrow 2278 directs execution from operation 2276 to operation 2280. Operation 2280 performs sending a bid contract message based upon the agreed contract to the bid client. Arrow 2282 directs execution from operation 2280 to operation 2284. Operation 2284 performs sending an ask contract message based upon the agreed contract to the ask client. Arrow 2286 directs execution from operation 2284 to operation 2288. Operation 2288 terminates the operations of this flowchart.

These operations may be supported by a program step residing in a coupled computer readable memory on at least one computer in a computing system supporting a virtual trading floor for ephemeral, fungible commodities.

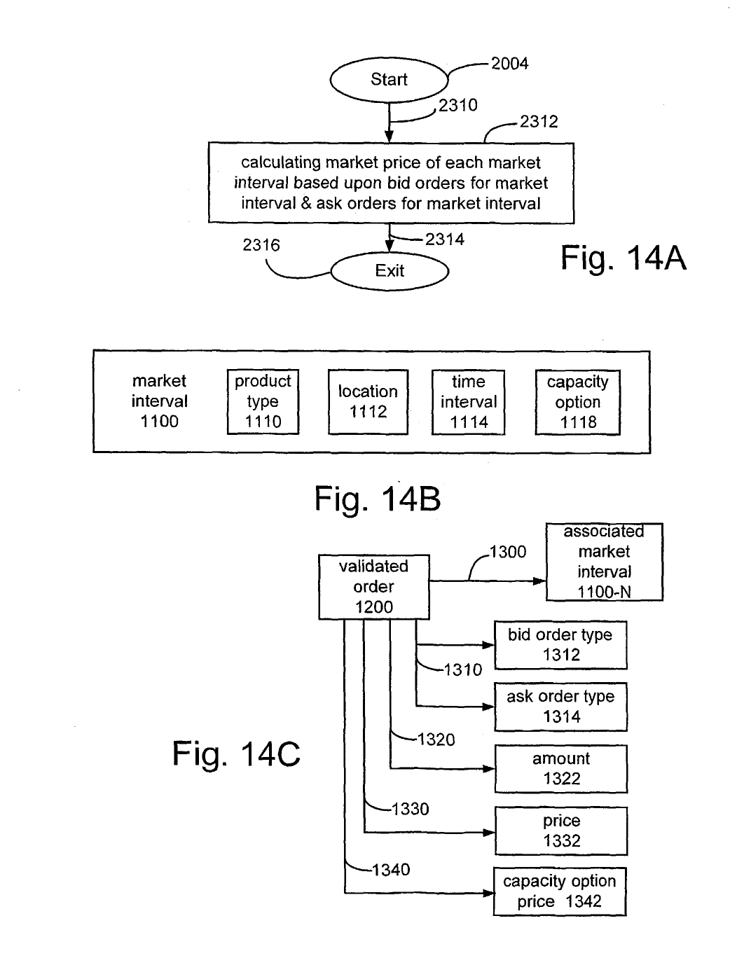

FIG. 14A depicts a detail flowchart of operation 2004 of FIG. 4 performing calculating the market price of each market interval in the market interval collection.

Arrow 2310 directs the flow of execution from starting operation 2004 to operation 2312. Operation 2312 performs calculating the associated market price of each of the market intervals of the market interval collection based upon the bid validated orders of the validated order collection for the market interval and the ask validated orders of the validated order collection for the market interval. Arrow 2314 directs execution from operation 2312 to operation 2316. Operation 2316 terminates the operations of this flowchart.

These operations may be supported by a program step residing in a coupled computer readable memory on at least one computer in a computing system supporting a virtual trading floor for ephemeral, fungible commodities.

FIG. 14B depicts a refinement of FIG. 3B of a market interval 1100 further containing a capacity option type 1118. In certain embodiments of the invention, capacity options are found as ancillary services in AC power networks providing network operators real-time resources to maintain AC power network operational parameters within regulatory and safety limits. In certain other embodiments of the invention, capacity options may be used by certified clients to provide for rapidly applied increases from production facilities of ephemeral, fungible commodities being traded on the virtual trading floor.

FIG. 14C depicts a refinement of the validated order of FIG. 5B further containing 1340 a capacity option price 1342. Capacity options may be traded to permit reservation of an ephemeral, fungible commodity amount. Such reservations have a price, the capacity option price, besides just a price of purchase. In agreeing to a capacity option contract, the seller is only guaranteed the earnings of the capacity option price, and the buyer acquires the right to buy the amount of capacity at or close to real time (subject to scheduling constraints). If the buyer elects to buy the optioned capacity, it is at the price already agreed upon in the contract. The seller then makes additional income from the actual purchased amount at the agreed price.

The virtual trading floor may apply to a power grid containing at least one AC power network, and capacity options can exist for a variety of generation options, including what are sometimes known as spinning and non-spinning resources. Spinning resources are often turbine generators rotating already at operational speed, and thus can be brought on line in a short time. Non-spinning resources include turbines, which are either still, or far below operational rates. Such turbines often take 15-30 minutes to come up to operational speed. These operational distinctions are part of the scheduling constraints that guide the use of such capacity option activities.

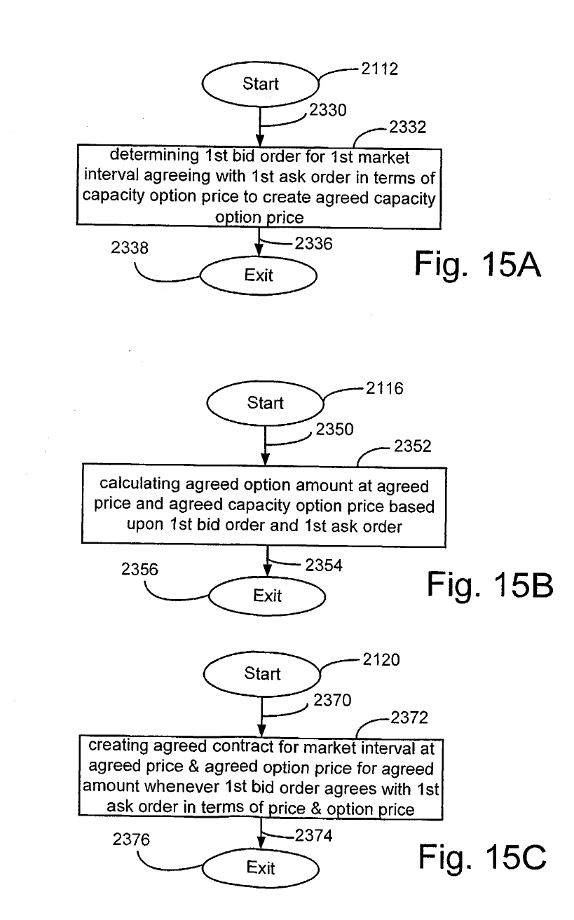

FIG. 15A depicts a detail flowchart of operation 2112 of FIG. 10B performing determining bid order agreement with ask order for an associated capacity option market interval.

Arrow 2330 directs the flow of execution from starting operation 2112 to operation 2332. Operation 2332 performs determining a first bid validated order for a first market interval agreeing with a first ask validated order for the first market interval in terms of capacity option price to create an agreed capacity option price. Arrow 2334 directs execution from operation 2332 to operation 2336. Operation 2336 terminates the operations of this flowchart.

These operations may be supported by a program step residing in a coupled computer readable memory on at least one computer in a computing system supporting a virtual trading floor for ephemeral, fungible commodities.

FIG. 15B depicts a detail flowchart of operation 2116 of FIG. 10B performing calculating an agreed option amount.

Arrow 2350 directs the flow of execution from starting operation 2116 to operation 2352. Operation 2352 performs calculating an agreed option amount for the market interval at the agreed price and the agreed capacity option price based upon the first bid validated order and first ask validated order. Arrow 2354 directs execution from operation 2352 to operation 2356. Operation 2356 terminates the operations of this flowchart.

These operations may be supported by a program step residing in a coupled computer readable memory on at least one computer in a computing system supporting a virtual trading floor for ephemeral, fungible commodities.

FIG. 15C depicts a detail flowchart of operation 2120 of FIG. 10B performing creating the agreed contract at the agreed price and the agreed option price for the agreed amount whenever the first bid order agrees with the first ask order in terms of the price and the option price.

Arrow 2370 directs the flow of execution from starting operation 2120 to operation 2372. Operation 2372 performs creating the agreed contract for the market interval at the agreed price and the agreed option price for the agreed amount whenever the first bid validated order agrees with the first ask validated order in terms of the price and the option price. Arrow 2374 directs execution from operation 2372 to operation 2376. Operation 2376 terminates the operations of this flowchart.

These operations may be supported by a program step residing in a coupled computer readable memory on at least one computer in a computing system supporting a virtual trading floor for ephemeral, fungible commodities.

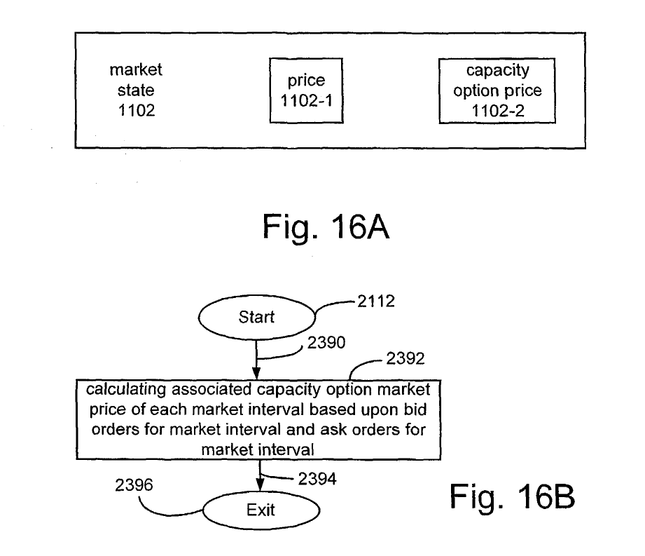

FIG. 16A depicts a market state 1102 associated with a market interval 1100 as show in FIGS. 3A and 14B in accordance with certain embodiments of the invention.

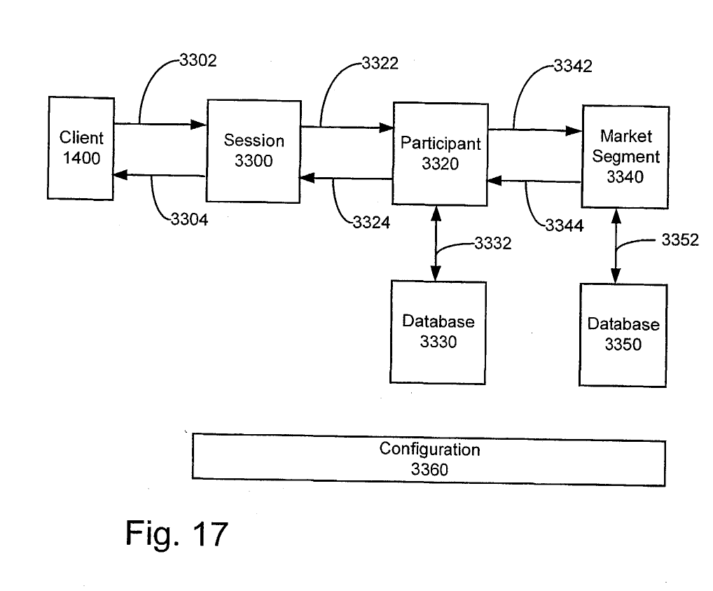

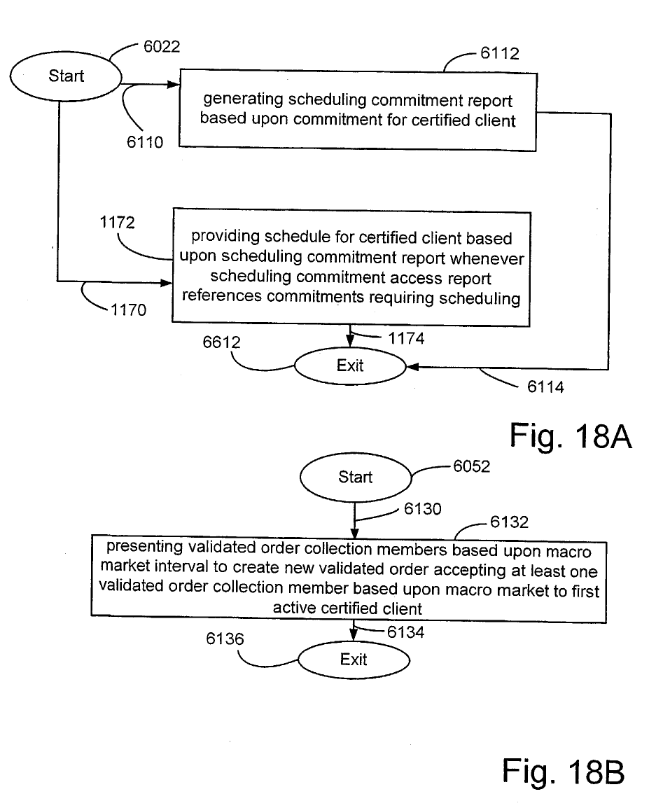

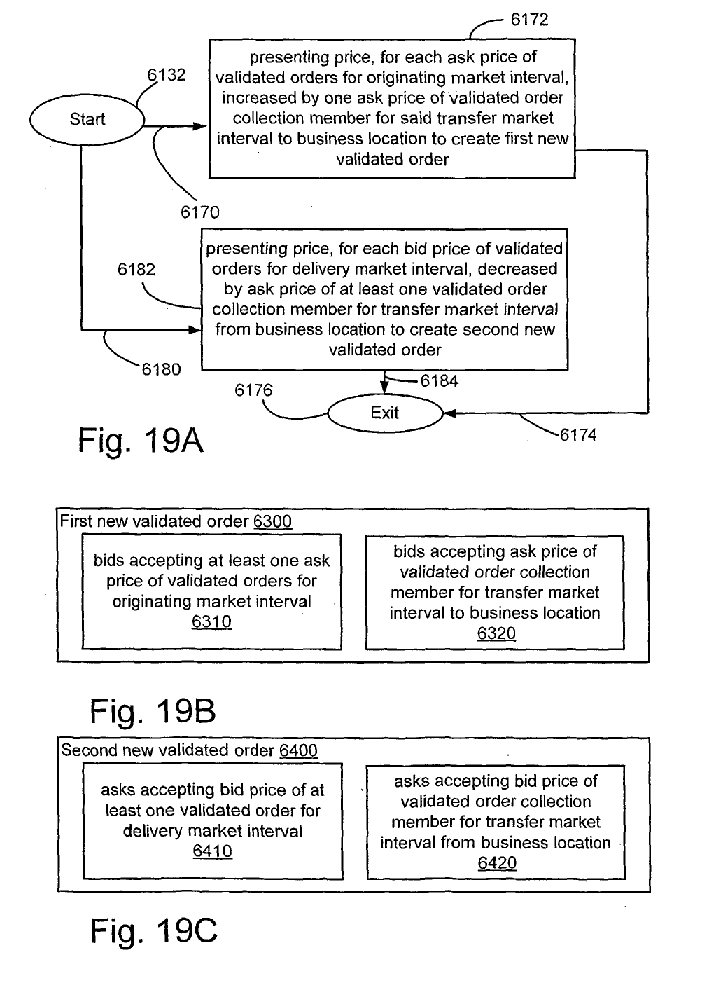

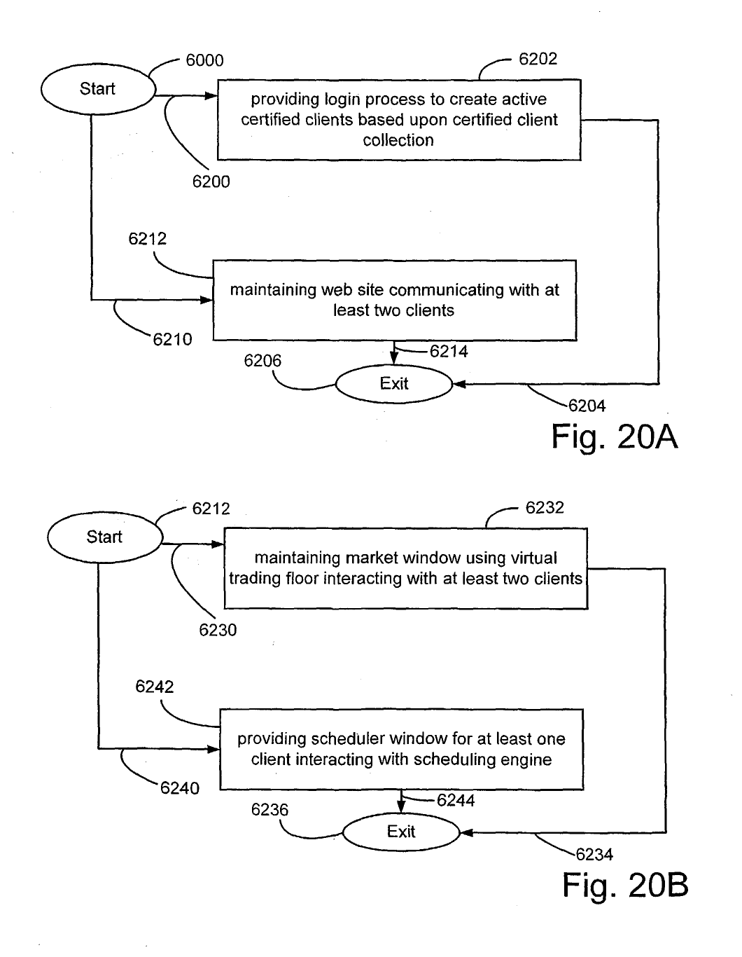

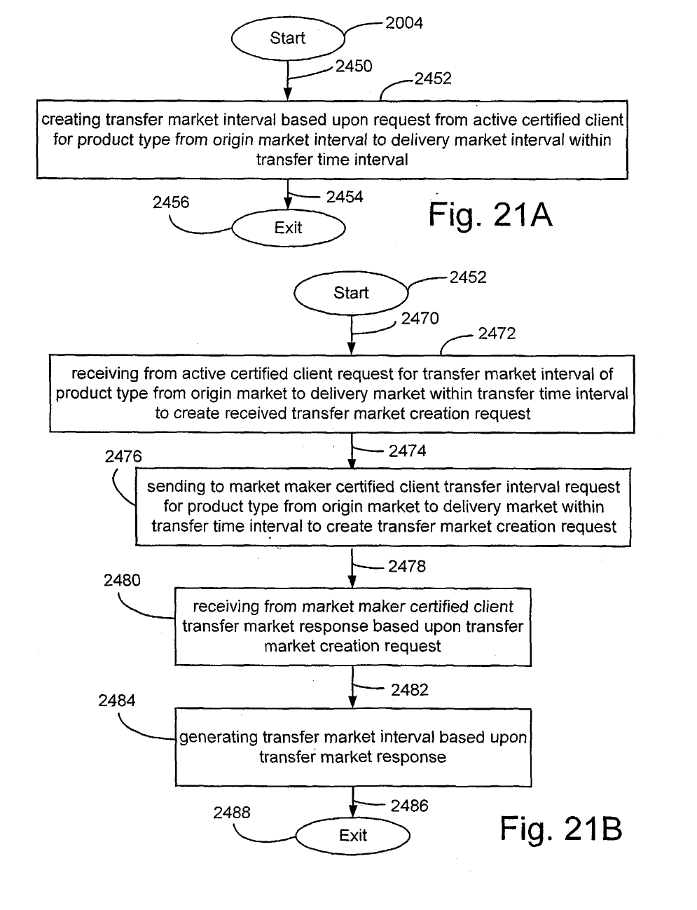

Market state 1102 may include a price 1102-1. Market state 1102 may be further associated with a market interval 1100 containing a capacity option type 1118 as shown in FIG. 17B. Market state 1102 may further contain a capacity option price 1102-2.

FIG. 16B depicts a detail flowchart of operation 2004 of FIG. 14A performing calculating the capacity option price 1102-2 for the market state 1102 as shown in FIG. 16A of a market interval as shown in FIG. 14B containing a capacity option 1118.

Arrow 2390 directs the flow of execution from starting operation 2004 to operation 2392. Operation 2392 performs calculating the associated capacity option market price of each market interval based upon the bid validated orders of the validated order collection for the market interval and the ask validated orders of the validated order collection for the market interval. Arrow 2394 directs execution from operation 2392 to operation 2396. Operation 2396 terminates the operations of this flowchart.

FIG. 17 depicts a method of controlling the interaction between a client 1400 and a virtual trading floor comprising maintaining a session component 3300, participant component 3320 and market segment 3340 in accordance with certain embodiments of the invention.

Maintaining the session component 3300 may comprise the following: Receiving an order request message 3302 from client 2190. Sending the received order request message 3322 to the participant component 3320 to create a forwarded order request message for the participant component. Receiving 3324 the acknowledgement message based upon the validated order request message and the relevant client list message for the validated order request message. Processing the received acknowledgement message and relevant client list for the validated order request message to create a broadcast update message for the validated order request message. Sending the broadcast update message 3304 to each of the clients 2190 of the relevant client list.

Maintaining the participant component 3320 may further comprise the following: Receiving the forwarded order request message 3302 from the session component. Maintaining 3332 a participant database 3330. Validating the received, forwarded order request message. And responding to the validated order request message whenever the received, forwarded order request message is validated.

Maintaining the participant database may further comprise the following. Adding the received, forwarded order request message 3332 to the participant database 3330. Validating the received, forwarded ordered request message requires examining 3324 and 3322 the session database based upon the received, forwarded order request message to create a validated order request message.

Responding to a validated message may comprise the participant component performing the following activities. Sending an acknowledgement message 3324 based upon the validated order request message to the session component 3300. Assembling a list of relevant clients for the validated order request message and sending 3324 the session component 3300 a relevant client list message for the validated order request message. Sending a market order request message 3342 to the market segment 3340 based upon the validated order request message.

Maintaining the market segment 3340 may comprise performing the following activities. Receiving the market order request message 3342. Maintaining 3352 a market segment database 3350 comprised of market intervals with associated market states as either active or closed. The market state of an active market interval comprises the total pending buy-position and the total pending sell-position.

A market segment may be considered the virtual trading floor for specific fungible, ephemeral commodities such as electricity commodities including, but not limited to, “energy”, “spinning reserve” and “transmission rights”. Additionally, a market segment is associated with a particular location, such as a delivery zone, hub or node in a grid, or a transmission path between two nodes in an AC electrical power network.

Maintaining the market segment database 3350 may comprise performing the following activities. Updating the market state of at least one market interval 3352 based upon the received market order request message 3342. Reconciling the total pending buy-position with the total pending sell-position of at least one market interval. Closing a market interval.

A virtual trading mechanism database may comprise a read-only database 3360 for market configuration and for participant configuration by the virtual trading mechanism. Settlement and schedule databases may not be directly accessed by the virtual trading mechanism in certain embodiments of the invention.

FIG. 18A depicts a detail flowchart of operation 2004 of FIG. 4B further maintaining the market interval collection.

Arrow 2450 directs the flow of execution from starting operation 2004 to operation 2452. Operation 2452 performs creating the macro market interval based upon a request from the active certified client for the product type from the source market interval to the delivery market interval within a transfer time interval. Arrow 2454 directs execution from operation 2452 to operation 2456. Operation 2456 terminates the operations of this flowchart.

FIG. 18B depicts a detail flowchart of operation 2452 of FIG. 18A further creating the macro market interval.

Arrow 2470 directs the flow of execution from starting operation 2452 to operation 2472. Operation 2472 performs sending to the market maker certified client a transfer interval request for the product type from the source market to the delivery market within the transfer time interval to create a transfer market creation request. Arrow 2474 directs execution from operation 2472 to operation 2476. Operation 2476 performs receiving from the market maker certified client a transfer market response based upon the transfer market creation request. Arrow 2478 directs execution from operation 2476 to operation 2480. Operation 2480 performs generating the transfer market interval based upon the transfer market response. Arrow 2482 directs execution from operation 2480 to operation 2484. Operation 2484 performs referencing the transfer market interval within the macro market interval. Arrow 2486 directs execution from operation 2484 to operation 2488. Operation 2488 terminates the operations of this flowchart.

The preceding embodiments have been provided by way of example and are not meant to constrain the scope of the following claims.

1. A system interacting with at least a first active certified client, a second active certified client and a market maker certified client all belonging to a certified client collection supporting transactions involving at least one fungible, non-ephemeral commodity, comprising:
a computing system interacting with at least said first active certified client, said second active certified client and said market maker certified client and controlled by at least a program system comprised of program steps contained in memory accessibly coupled to at least one computer included in the computing system, and
wherein a macro market interval for a product type references a source market interval of said product type and references a delivery market interval of said product type with a transfer market interval of said product type; wherein said transfer market interval includes a time interval starts near a time interval for said source market interval and said time interval ends near said time interval of said delivery market interval;
said program system comprising the program steps of:
operating a virtual trading floor interacting with said active certified clients in terms of said macro market and source market interval and said delivery market interval and said delivery market interval to create said commitment;
operating a scheduling engine providing at least one schedule based upon said commitment for at least one of said certified clients belonging to said certified client collection; and
wherein the program step operating said scheduling engine is further comprised of, for each of said certified clients belonging to said certified client collection, the program steps of:
sending a scheduling commitment access request for said certified client regarding said commitment;
receiving a scheduling commitment report in response to said scheduling commitment access request based upon said commitment to create the received scheduling commitment report for said certified client; and
generating said schedule for said certified client based upon the received scheduling commitment report for said certified client whenever the received scheduling commitment access report references commitments requiring scheduling;
wherein the program step operating said virtual trading floor comprising the program steps of:
maintaining a market interval collection of at least said macro market interval, said source market interval and said delivery market interval and said transfer market interval;
maintaining a validated order collection of at least one validated orders associated with at least one of said macro market intervals; and
contracting to create an agreed contract to be added to a commitment list, where the agreed contract is based upon at least two validated orders from the validated order collection.

2. The system of claim 1,
wherein said program system further comprises the program step of:
providing a login process to create said active certified clients based upon said certified client collection.

3. The system of claim 1,
wherein said program system further comprises the program step of:
maintaining a web site communicating with at least two clients and further comprising at least one of the collection comprising the program steps of:
maintaining a market window using said virtual trading floor interacting with said clients;
providing a scheduler window for said client interacting with said scheduling engine.

4. The system of claim 1,
wherein the program step operating said scheduling engine is further comprised of the program step of
processing a capacity option request by interacting with said market engine.

5. The system of claim 4,
wherein the program step processing said capacity option request is further comprised of the program steps of
receiving said capacity option request from said first active certified client with operator authorization to create a received capacity option request from said first active certified client;
accessing said validated order collection based upon said received capacity option request to create a capacity option offer list containing a reference to each of said validated orders contained in said validated order collection matching said received capacity option request; and
processing said capacity option offer list.

6. The system of claim 5,
wherein the program step processing said capacity offer list is further comprised of the program step of:
presenting said capacity offer list to said first active certified client.

7. The system of claim 5,
wherein said received capacity option request includes a market interval and includes an ask-limit amount and includes an ask-limit price;
wherein the program step processing said capacity offer list is further comprised of the program step of:
examining said capacity offer list based upon said market interval and based upon said ask-limit amount and based upon said ask-limit price to create an acceptable offer capacity list and to create a potentially eligible offer capacity list;
asking for said acceptable offer capacity list based upon said ask-limit amount and based upon said ask-limit price to said virtual trading floor to create an ask validated order in said market interval for said first active client; and
presenting said potentially eligible capacity offer list to said first active certified client whenever said acceptable offer capacity list does not cover said ask-limit amount.

8. The system of claim 1,
wherein the program step operating said market engine is further comprised of the program steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

9. The system of claim 8,
wherein the program step of recording said validated orders into said transaction database is further comprised of the program step of:
recording a contracted position for said market interval for each of said certified clients in said certified client collection based upon all validated orders involving said certified client and containing said market interval in said validated order collection into said transaction database.

10. The system of claim 9,
wherein the program step of recording the validated orders into the transaction database is further comprised of at least one the program steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

11. The system of claim 1,
wherein the program step maintaining said market interval collection is further comprised of the program steps of:
creating said macro market interval based upon a request from said active certified client for said product type from said source market interval to said delivery market interval within a transfer time interval;
wherein the program step creating said macro market interval is further comprised of the program steps of
sending to said market maker certified client a transfer interval request for said product type from said source market to said delivery market within said transfer time interval to create a transfer market creation request;
receiving from said market maker certified client a transfer market response based upon said transfer market creation request;
generating said transfer market interval based upon said transfer market response; and
referencing said transfer market interval within said macro market interval.

12. A method supporting transactions involving at least one fungible, non-ephemeral commodity through interactions with at least a first active certified client, a second active certified client and a market maker certified client all belonging to a certified client collection,
wherein a macro market interval for a product type references a source market interval of said product type and references a delivery market interval of said product type with a transfer market interval of said product type; wherein said transfer market interval includes a time interval starts near a time interval for said source market interval and said time interval ends near said time interval of said delivery market interval;
said method comprising the steps of:
operating a virtual trading floor interacting with said active certified clients in terms of said macro market and source market interval and said delivery market interval and said delivery market interval to create said commitment;
operating a scheduling engine providing at least one schedule based upon said commitment for at least one of said certified clients belonging to said certified client collection; and
wherein the step operating said scheduling engine is further comprised of, for each of said certified clients belonging to said certified client collection, the steps of:
sending a scheduling commitment access request for said certified client regarding said commitment;
receiving a scheduling commitment report in response to said scheduling commitment access request based upon said commitment to create the received scheduling commitment report for said certified client; and
generating said schedule for said certified client based upon the received scheduling commitment report for said certified client whenever the received scheduling commitment access report references commitments requiring scheduling;
wherein the step operating said virtual trading floor comprising the steps of:
maintaining a market interval collection of at least said macro market interval, said source market interval and said delivery market interval and said transfer market interval;
maintaining a validated order collection of at least one validated orders associated with at least one of said macro market intervals; and
contracting to create an agreed contract to be added to a commitment list, where the agreed contract is based upon at least two validated orders from the validated order collection.

13. The method of claim 12, further comprising the step of:
providing a login process to create said active certified clients based upon said certified client collection.

14. The method of claim 12, further comprising the step of:
maintaining a web site communicating with at least two clients and further comprising at least one of the collection comprising the steps of:
maintaining a market window using said virtual trading floor interacting with said clients;
providing a scheduler window for said client interacting with said scheduling engine.

15. The method of claim 12,
wherein the step operating said scheduling engine is further comprised of the step of
processing a capacity option request by interacting with said market engine.

16. The method of claim 15,
wherein the step processing said capacity option request is further comprised of the steps of
receiving said capacity option request from said first active certified client with operator authorization to create a received capacity option request from said first active certified client;
accessing said validated order collection based upon said received capacity option request to create a capacity option offer list containing a reference to each of said validated orders contained in said validated order collection matching said received capacity option request; and
processing said capacity option offer list.

17. The method of claim 16,
wherein the step processing said capacity offer list is further comprised of the step of:
presenting said capacity offer list to said first active certified client.

18. The method of claim 16,
wherein said received capacity option request includes a market interval and includes an ask-limit amount and includes an ask-limit price;
wherein the step processing said capacity offer list is further comprised of the step of:
examining said capacity offer list based upon said market interval and based upon said ask-limit amount and based upon said ask-limit price to create an acceptable offer capacity list and to create a potentially eligible offer capacity list;
asking for said acceptable offer capacity list based upon said ask-limit amount and based upon said ask-limit price to said virtual trading floor to create an ask validated order in said market interval for said first active client; and
presenting said potentially eligible capacity offer list to said first active certified client whenever said acceptable offer capacity list does not cover said ask-limit amount.

19. The method of claim 12,
wherein the step operating said market engine is further comprised of the steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

20. The method of claim 19,
wherein the step of recording said validated orders into said transaction database is further comprised of the step of:
recording a contracted position for said market interval for each of said certified clients in said certified client collection based upon all validated orders involving said certified client and containing said market interval in said validated order collection into said transaction database.

21. The method of claim 20,
wherein the step of recording the validated orders into the transaction database is further comprised of at least one the steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

22. The method of claim 12,
wherein the step maintaining said market interval collection is further comprised of the steps of:
creating said macro market interval based upon a request from said active certified client for said product type from said source market interval to said delivery market interval within a transfer time interval;
wherein the step creating said macro market interval is further comprised of the steps of
sending to said market maker certified client a transfer interval request for said product type from said source market to said delivery market within said transfer time interval to create a transfer market creation request;
receiving from said market maker certified client a transfer market response based upon said transfer market creation request;
generating said transfer market interval based upon said transfer market response; and
referencing said transfer market interval within said macro market interval.

23. A method supporting transactions involving at least one fungible, non-ephemeral commodity through interactions with at least a first active certified client and a second active certified client and a market maker certified client all belonging to a certified client collection,
wherein a macro market interval for a product type references a source market interval of said product type and references a delivery market interval of said product type with a transfer market interval of said product type; wherein said transfer market interval includes a time interval starts near a time interval for said source market interval and said time interval ends near said time interval of said delivery market interval;
said method comprising the steps of:
operating a virtual trading floor interacting with said active certified clients in terms of said macro market and source market interval and said delivery market interval and said delivery market interval to create said commitment;
wherein the step operating said virtual trading floor comprising the steps of:
maintaining a market interval collection of at least said macro market interval, said source market interval and said delivery market interval and said transfer market interval;
maintaining a validated order collection of at least one validated orders associated with at least one of said macro market intervals; and
contracting to create an agreed contract to be added to a commitment list, where the agreed contract is based upon at least two validated orders from the validated order collection.

24. The method of claim 23, further comprising the step of:
providing a login process to create said active certified clients based upon said certified client collection.

25. The method of claim 23, further comprising the step of:
maintaining a web site communicating with at least two clients and further comprising the step of:
maintaining a market window using said virtual trading floor interacting with said clients.

26. The method of claim 23,
wherein the step operating said market engine is further comprised of the steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

27. The method of claim 26,
wherein the step of recording said validated orders into said transaction database is further comprised of the step of:
recording a contracted position for said market interval for each of said certified clients in said certified client collection based upon all validated orders involving said certified client and containing said market interval in said validated order collection into said transaction database.

28. The method of claim 27,
wherein the step of recording the validated orders into the transaction database is further comprised of at least one the steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

29. The method of claim 23,
wherein the step maintaining said market interval collection is further comprised of the steps of:
creating said macro market interval based upon a request from said active certified client for said product type from said source market interval to said delivery market interval within a transfer time interval;
wherein the step creating said macro market interval is further comprised of the steps of
sending to said market maker certified client a transfer interval request for said product type from said source market to said delivery market within said transfer time interval to create a transfer market creation request;
receiving from said market maker certified client a transfer market response based upon said transfer market creation request;
generating said transfer market interval based upon said transfer market response; and
referencing said transfer market interval within said macro market interval.

30. A method supporting transactions involving at least one fungible, ephemeral commodity through interactions with at least a first active certified client, a second active certified client and a market maker certified client all belonging to a certified client collection,
wherein a macro market interval for a product type references a source market interval of said product type by a source location and references a delivery market interval of said product type by a delivery location with a transfer market interval of said product type by a time interval;
said method comprising the steps of:
operating a virtual trading floor interacting with said active certified clients in terms of said macro market and source market interval and said delivery market interval and said delivery market interval to create said commitment;
operating a scheduling engine providing at least one schedule based upon said commitment for at least one of said certified clients belonging to said certified client collection; and
wherein the step operating said scheduling engine is further comprised of, for each of said certified clients belonging to said certified client collection, the steps of:
sending a scheduling commitment access request for said certified client regarding said commitment;
receiving a scheduling commitment report in response to said scheduling commitment access request based upon said commitment to create the received scheduling commitment report for said certified client; and
generating said schedule for said certified client based upon the received scheduling commitment report for said certified client whenever the received scheduling commitment access report references commitments requiring scheduling;
wherein the step operating said virtual trading floor comprising the steps of:
maintaining a market interval collection of at least said macro market interval, said source market interval and said delivery market interval and said transfer market interval;
maintaining a validated order collection of at least one validated orders associated with at least one of said macro market intervals; and
contracting to create an agreed contract to be added to a commitment list, where the agreed contract is based upon at least two validated orders from the validated order collection.

31. The method of claim 30, further comprising the step of:
providing a login process to create said active certified clients based upon said certified client collection.

32. The method of claim 30, further comprising the step of:
maintaining a web site communicating with at least two clients and further comprising at least one of the collection comprising the steps of:
maintaining a market window using said virtual trading floor interacting with said clients;
providing a scheduler window for said client interacting with said scheduling engine.

33. The method of claim 30,
wherein the step operating said scheduling engine is further comprised of the step of
processing a capacity option request by interacting with said market engine.

34. The method of claim 33,
wherein the step processing said capacity option request is further comprised of the steps of
receiving said capacity option request from said first active certified client with operator authorization to create a received capacity option request from said first active certified client;
accessing said validated order collection based upon said received capacity option request to create a capacity option offer list containing a reference to each of said validated orders contained in said validated order collection matching said received capacity option request; and
processing said capacity option offer list.

35. The method of claim 34,
wherein the step processing said capacity offer list is further comprised of the step of:
presenting said capacity offer list to said first active certified client.

36. The method of claim 34,
wherein said received capacity option request includes a market interval and includes an ask-limit amount and includes an ask-limit price;
wherein the step processing said capacity offer list is further comprised of the step of:
examining said capacity offer list based upon said market interval and based upon said ask-limit amount and based upon said ask-limit price to create an acceptable offer capacity list and to create a potentially eligible offer capacity list;
asking for said acceptable offer capacity list based upon said ask-limit amount and based upon said ask-limit price to said virtual trading floor to create an ask validated order in said market interval for said first active client; and
presenting said potentially eligible capacity offer list to said first active certified client whenever said acceptable offer capacity list does not cover said ask-limit amount.

37. The method of claim 30,
wherein the step operating said market engine is further comprised of the steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

38. The method of claim 37,
wherein the step of recording said validated orders into said transaction database is further comprised of the step of:
recording a contracted position for said market interval for each of said certified clients in said certified client collection based upon all validated orders involving said certified client and containing said market interval in said validated order collection into said transaction database.

39. The method of claim 38,
wherein the step of recording the validated orders into the transaction database is further comprised of at least one the steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

40. The method of claim 30,
wherein the step maintaining said market interval collection is further comprised of the steps of:
creating said macro market interval based upon a request from said active certified client for said product type from said source market interval to said delivery market interval within a transfer time interval;
wherein the step creating said macro market interval is further comprised of the steps of
sending to said market maker certified client a transfer interval request for said product type from said source market to said delivery market within said transfer time interval to create a transfer market creation request;
receiving from said market maker certified client a transfer market response based upon said transfer market creation request;
generating said transfer market interval based upon said transfer market response; and
referencing said transfer market interval within said macro market interval.

41. A method supporting transactions involving at least one fungible, ephemeral commodity through interaction with at least a first active certified client and a second active certified client and a market maker certified client all belonging to a certified client collection,
wherein a macro market interval for a product type references a source market interval of said product type by a source location and references a delivery market interval of said product type by a delivery location with a transfer market interval of said product type by a time interval;
said method comprising the steps of:
operating a virtual trading floor interacting with said active certified clients in terms of said macro market and source market interval and said delivery market interval and said delivery market interval to create said commitment;
wherein the step operating said virtual trading floor comprising the steps of:
maintaining a market interval collection of at least said macro market interval, said source market interval and said delivery market interval and said transfer market interval;
maintaining a validated order collection of at least one validated orders associated with at least one of said macro market intervals; and
contracting to create an agreed contract to be added to a commitment list, where the agreed contract is based upon at least two validated orders from the validated order collection.

42. The method of claim 41, further comprising the step of:
providing a login process to create said active certified clients based upon said certified client collection.

43. The method of claim 41, further comprising the step of:
maintaining a web site communicating with at least two clients and further comprising the steps of:
maintaining a market window using said virtual trading floor interacting with said clients.

44. The method of claim 41,
wherein the step operating said market engine is further comprised of the steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

45. The method of claim 44,
wherein the step of recording said validated orders into said transaction database is further comprised of the step of:
recording a contracted position for said market interval for each of said certified clients in said certified client collection based upon all validated orders involving said certified client and containing said market interval in said validated order collection into said transaction database.

46. The method of claim 45,
wherein the step of recording the validated orders into the transaction database is further comprised of at least one the steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

47. The method of claim 41,
wherein the step maintaining said market interval collection is further comprised of the steps of:
creating said macro market interval based upon a request from said active certified client for said product type from said source market interval to said delivery market interval within a transfer time interval;
wherein the step creating said macro market interval is further comprised of the steps of
sending to said market maker certified client a transfer interval request for said product type from said source market to said delivery market within said transfer time interval to create a transfer market creation request;
receiving from said market maker certified client a transfer market response based upon said transfer market creation request;
generating said transfer market interval based upon said transfer market response; and
referencing said transfer market interval within said macro market interval.

48. A system interacting with at least a first active certified client and a second active certified client and a market maker certified client all belonging to a certified client collection supporting transactions involving at least one fungible, ephemeral commodity, comprising:
a computing system interacting with at least said first active certified client and said second certified client and said market maker certified client and controlled by at least a program system comprised of program steps contained in memory accessibly coupled to at least one computer included in the computing system, and
wherein a macro market interval for a product type references a source market interval of said product type by a source location and references a delivery market interval of said product type by a delivery location with a transfer market interval of said product type by a time interval;
said program system comprising the program steps of:
operating a virtual trading floor interacting with said active certified clients in terms of said macro market and source market interval and said delivery market interval and said delivery market interval to create said commitment;
wherein the program step operating said virtual trading floor comprising the program steps of:
maintaining a market interval collection of at least said macro market interval, said source market interval and said delivery market interval and said transfer market interval;
maintaining a validated order collection of at least one validated orders associated with at least one of said macro market intervals; and
contracting to create an agreed contract to be added to a commitment list, where the agreed contract is based upon at least two validated orders from the validated order collection.

49. The system of claim 48,
wherein said program system further comprises the program step of:
providing a login process to create said active certified clients based upon said certified client collection.

50. The system of claim 48,
wherein said program system further comprises the program step of:
maintaining a web site communicating with at least two clients and further comprising the program steps of:
maintaining a market window using said virtual trading floor interacting is with said clients.

51. The system of claim 48,
wherein the program step operating said market engine is further comprised of the program steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

52. The system of claim 51,
wherein the program step of recording said validated orders into said transaction database is further comprised of the program step of:
recording a contracted position for said market interval for each of said certified clients in said certified client collection based upon all validated orders involving said certified client and containing said market interval in said validated order collection into said transaction database.

53. The system of claim 52,
wherein the program step of recording the validated orders into the transaction database is further comprised of at least one the program steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

54. The system of claim 48,
wherein the program step maintaining said market interval collection is further comprised of the program steps of:
creating said macro market interval based upon a request from said active certified client for said product type from said source market interval to said delivery market interval within a transfer time interval;
wherein the program step creating said macro market interval is further comprised of the program steps of
sending to said market maker certified client a transfer interval request for said product type from said source market to said delivery market within said transfer time interval to create a transfer market creation request;
receiving from said market maker certified client a transfer market response based upon said transfer market creation request;
generating said transfer market interval based upon said transfer market response; and
referencing said transfer market interval within said macro market interval.

55. A system interacting with at least a first active certified client and a second active certified client and a market maker certified client all belonging to a certified client collection supporting transactions involving at least one fungible, non-ephemeral commodity, comprising:
a computing system interacting with at least said first active certified client and said second certified client and said market maker certified client and controlled by at least a program system comprised of program steps contained in memory accessibly coupled to at least one computer included in the computing system, and
wherein a macro market interval for a product type references a source market interval of said product type and references a delivery market interval of said product type with a transfer market interval of said product type; wherein said transfer market interval includes a time interval starts near a time interval for said source market interval and said time interval ends near said time interval of said delivery market interval;
said program system comprising the program steps of:
operating a virtual trading floor interacting with said active certified clients in terms of said macro market and source market interval and said delivery market interval and said delivery market interval to create said commitment;
wherein the program step operating said virtual trading floor comprising the program steps of:
maintaining a market interval collection of at least said macro market interval, said source market interval and said delivery market interval and said transfer market interval;
maintaining a validated order collection of at least one validated orders associated with at least one of said macro market intervals; and
contracting to create an agreed contract to be added to a commitment list, where the agreed contract is based upon at least two validated orders from the validated order collection.

56. The system of claim 55,
wherein said program system further comprises the program step of:
providing a login process to create said active certified clients based upon said certified client collection.

57. The system of claim 55,
wherein said program system further comprises the program step of:
maintaining a web site communicating with at least two clients and further comprising the program steps of:
maintaining a market window using said virtual trading floor interacting with said clients.

58. The system of claim 55,
wherein the program step operating said market engine is further comprised of the program steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

59. The system of claim 58,
wherein the program step of recording said validated orders into said transaction database is further comprised of the program step of:
recording a contracted position for said market interval for each of said certified clients in said certified client collection based upon all validated orders involving said certified client and containing said market interval in said validated order collection into said transaction database.

60. The system of claim 59,
wherein the program step of recording the validated orders into the transaction database is further comprised of at least one the program steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

61. The system of claim 55,
wherein the program step maintaining said market interval collection is further comprised of the program steps of:
creating said macro market interval based upon a request from said active certified client for said product type from said source market interval to said delivery market interval within a transfer time interval;
wherein the program step creating said macro market interval is further comprised of the program steps of
sending to said market maker certified client a transfer interval request for said product type from said source market to said delivery market within said transfer time interval to create a transfer market creation request;
receiving from said market maker certified client a transfer market response based upon said transfer market creation request;
generating said transfer market interval based upon said transfer market response; and
referencing said transfer market interval within said macro market interval.

62. A system interacting with at least a first active certified client, a second active certified client and a market maker certified client all belonging to a certified client collection supporting transactions involving at least one fungible, ephemeral commodity, comprising:
a computing system interacting with at least said first active certified client, said second active certified client and said market maker certified client and controlled by at least a program system comprised of program steps contained in memory accessibly coupled to at least one computer included in the computing system, and
wherein a macro market interval for a product type references a source market interval of said product type by a source location and references a delivery market interval of said product type by a delivery location with a transfer market interval of said product type by a time interval;
said program system comprising the program steps of:
operating a virtual trading floor interacting with said active certified clients in terms of said macro market and source market interval and said delivery market interval and said delivery market interval to create said commitment;
operating a scheduling engine providing at least one schedule based upon said commitment for at least one of said certified clients belonging to said certified client collection; and
wherein the program step operating said scheduling engine is further comprised of, for each of said certified clients belonging to said certified client collection, the program steps of:
sending a scheduling commitment access request for said certified client regarding said commitment;
receiving a scheduling commitment report in response to said scheduling commitment access request based upon said commitment to create the received scheduling commitment report for said certified client; and
generating said schedule for said certified client based upon the received scheduling commitment report for said certified client whenever the received scheduling commitment access report references commitments requiring scheduling;
wherein the program step operating said virtual trading floor comprising the program steps of:
maintaining a market interval collection of at least said macro market interval, said source market interval and said delivery market interval and said transfer market interval;
maintaining a validated order collection of at least one validated orders associated with at least one of said macro market intervals; and
contracting to create an agreed contract to be added to a commitment list, where the agreed contract is based upon at least two validated orders from the validated order collection.

63. The system of claim 62,
wherein said program system further comprises the program step of:
providing a login process to create said active certified clients based upon said certified client collection.

64. The system of claim 62,
wherein said program system further comprises the program step of:
maintaining a web site communicating with at least two clients and further comprising at least one of the collection comprising the program steps of:
maintaining a market window using said virtual trading floor interacting with said clients;
providing a scheduler window for said client interacting with said scheduling engine.

65. The system of claim 62,
wherein the program step operating said scheduling engine is further comprised of the program step of
processing a capacity option request by interacting with said market engine.

66. The system of claim 65,
wherein the program step processing said capacity option request is further comprised of the program steps of
receiving said capacity option request from said first active certified client with operator authorization to create a received capacity option request from said first active certified client;
accessing said validated order collection based upon said received capacity option request to create a capacity option offer list containing a reference to each of said validated orders contained in said validated order collection matching said received capacity option request; and
processing said capacity option offer list.

67. The system of claim 66,
wherein the program step processing said capacity offer list is further comprised of the program step of:
presenting said capacity offer list to said first active certified client.

68. The system of claim 66,
wherein said received capacity option request includes a market interval and includes an ask-limit amount and includes an ask-limit price;
wherein the program stop processing said capacity offer list is further comprised of the program step of:
examining said capacity offer list based upon said market interval and based upon said ask-limit amount and based upon said ask-limit price to create can acceptable offer capacity list and to create a potentially eligible offer capacity list;
asking for said acceptable offer capacity list based upon said ask-limit amount and based upon said ask-limit price to said virtual trading floor to create an ask validated order in said market interval for said first active client; and
presenting said potentially eligible capacity offer list to said first active certified client whenever said acceptable offer capacity list does not cover said ask-limit amount.

69. The system of claim 62,
wherein the program step operating said market engine is further comprised of the program steps of:
reconciling market positions for market intervals represented in said validated order collection;
adjusting market prices for market intervals represented in said validated order collection;
calculating market exposure for market intervals represented in said validated order collection;
marking said validated orders in said validated order collection onto a calendar;
recording said validated orders in said validated order collection to a transaction database.

70. The system of claim 69,
wherein the program step of recording said validated orders into said transaction database is further comprised of the program step of:
recording a contracted position for said market interval for each of said certified clients in said certified client collection based upon all validated orders involving said certified client and containing said market interval in said validated order collection into said transaction database.

71. The system of claim 70,
wherein the program step of recording the validated orders into the transaction database is further comprised of at least one the program steps of the collection comprising:
recording said market price for a market interval based upon all validated orders containing said market interval in said validated order collection into said transaction database;
recording a market volume for said market interval based upon all validated orders containing said market interval in said validated order collection into said transaction database; and
recording a marginal financial exposure for a market interval for each of said certified clients in said certified client collection based upon all validated orders involving said certified client and containing said market interval in said validated order collection into said transaction database.

72. The system of claim 62,
wherein the program step maintaining said market interval collection is further comprised of the program steps of:
creating said macro market interval based upon a request from said active certified client for said product type from said source market interval to said delivery market interval within a transfer time interval;
wherein the program step creating said macro market interval is further comprised of the program steps of
sending to said market maker certified client a transfer interval request for said product type from said source market to said delivery market within said transfer time interval to create a transfer market creation request;
receiving from said market maker certified client a transfer market response based upon said transfer market creation request;
generating said transfer market interval based upon said transfer market response; and
referencing said transfer market interval within said macro market interval.
